(19) United States
(12) Patent Application Publication
(10) Pub. No.: US 2026/0219550 A1
(43) Pub. Date: Jul. 30, 2026

(54) CAMERA ACTUATOR AND CAMERA MODULE COMPRISING SAME

(71) Applicant: LG INNOTEK CO., LTD., Seoul (KR)

(72) Inventors: Jae Moon WOO, Seoul (KR); Kyung Hwan KIM, Seoul (KR); Jeong Gi YOU, Seoul (KR); Sung Guk LEE, Seoul (KR)

(73) Assignee: LG INNOTEK CO., LTD., Seoul (KR)

(21) Appl. No.: 19/142,788

(22) PCT Filed: Jan. 15, 2024
(86) PCT No.: PCT/KR2024/000682

§ 371 Date: Jun. 24, 2025

(30) Foreign Application Priority Data
Jan. 18, 2023 (KR) 10-2023-0007552
Jan. 18, 2023 (KR) 10-2023-0007553

(51) Int. Cl. G03B 5/06

(52) U.S. Cl. CPC G03B 5/06; G03B 2205/0023; G03B 2205/0069

(57) ABSTRACT

An embodiment of the present invention discloses a camera actuator comprising: a housing; a mover including a holder and an optical member disposed on the holder; a driving unit that moves the mover; and a tilting guide portion disposed between the housing and the mover to guide tilting of the mover, wherein the housing includes a housing wall portion disposed on a side thereof corresponding to the exit surface of the optical member, and the housing wall portion is arranged apart from the holder in the optical axis direction.

### CROSS REFERENCE TO RELATED APPLICATIONS

This application is the National Phase of PCT/KR2024/000682 filed on Jan. 15, 2024, which claims priority under 35 U.S.C. § 119(a) to Patent Application Nos. 10-2023-0007552 and 10-2023-0007553 filed in the Republic of Korea on Jan. 18, 2023, all of which are hereby expressly incorporated by reference into the present application.

### TECHNICAL FIELD

The present invention relates to a camera actuator and a camera module including the same.

### BACKGROUND ART

Cameras are devices for taking pictures or videos by capturing images of subjects and are mounted on mobile devices, drones, vehicles, etc. To improve the quality of an image, a camera module may have an image stabilizer (IS) function for correcting or preventing an image shake caused by the movement of a user, an auto focusing (AF) function for aligning a focal length of a lens by automatically adjusting an interval between an image sensor and the lens, and a zooming function for capturing an image of a remote subject by increasing or decreasing the magnification of the image of the remote subject through a zoom lens.

However, to perform a hand-shake prevention function in the camera module, there is a need for a collision absorption structure for suppressing damage to a mover or the like due to a collision. Furthermore, there is a need for a structure that can easily suppress a movement radius of a mover, and the demand for preventing foreign substances from flowing into the inside, suppressing a leakage flux, and increasing attitude maintenance is also increasing. In addition, there is a need for a structure that minimizes the influence of a magnetic force due to magnets in performing a hand-shake prevention function or the like within the camera module.

### DETAILED DESCRIPTION OF INVENTION

### Technical Problem

The present invention is directed to providing a camera actuator and a camera device of which reliability is improved due to shock absorption occurring during driving of an optical image stabilizer (OIS).

In addition, embodiments of the present invention are directed to providing a camera actuator and a camera module which allow the introduction of foreign substances to be easily prevented.

In addition, embodiments of the present invention are directed to providing a camera actuator and a camera module capable of suppressing a phenomenon in which a contact point is changed by a deviation of dimensions and improve seating stability by deforming the shape of a protrusion groove.

In addition, embodiments are directed to providing a camera actuator and a camera module capable of achieving design easiness and suppressing the generation of an electromagnetic force by pressing a tilting guide part through an elastic member.

In addition, embodiments of the present invention are directed to providing a camera actuator and a camera module of which driving efficiency and balance are improved by adjusting a location of an elastic member.

The present invention is also directed to providing a camera actuator applicable to ultra-slim, ultra-small, and high-resolution cameras.

Objects of embodiments are not limited thereto and may also include objects or effects that may be identified from the configurations or embodiments to be described below.

### Technical Solution

A camera actuator according to an embodiment of the present invention includes a housing including a first housing side portion and a second housing side portion spaced apart from each other, a mover disposed between the first housing side portion and the second housing side portion and including a holder and an optical member disposed on the holder, a driving unit that moves the mover in an optical axis direction, and a tilting guide part disposed between the housing and the mover to guide tilting of the mover, wherein the housing includes a housing wall portion that extends from the first housing side portion and the second housing side portion and overlaps at least a portion of a holder disposed on a side portion corresponding to an exit surface of the optical member in the optical axis direction, and the housing wall portion is disposed to be spaced apart from the holder in the optical axis direction. The camera actuator may further include a first magnetic body disposed in the housing, and a second magnetic body disposed to face the first magnetic body, wherein the tilting guide part may press the mover due to a repulsive force between the first magnetic body and the second magnetic body.

A gap between the first magnetic body and the second magnetic body may be greater than a gap between the holder and the housing wall portion facing each other in the optical axis direction.

The housing may include a first member disposed at one side thereof, the mover may include a second member passing through the first member, the tilting guide part may be disposed between the first member and the mover, and a gap between the first member and the second member may be greater than a gap between the holder and the housing wall portion in the optical axis direction.

The first member may include a second groove located at an outer surface thereof, the second member may include a first groove facing the second groove, the first magnetic body may be disposed in the second groove, and the second magnetic body may be disposed in the first groove.

The first groove and the second groove may overlap each other in the optical axis direction.

The housing wall portion may not overlap the optical member in the optical axis direction.

At least a portion of the housing wall portion may overlap the holder in a direction perpendicular to the optical axis direction.

The driving unit may include a first magnet, a second magnet facing the first magnet, and a third magnet disposed between the second magnet and the second magnet.

The housing wall portion may overlap at least one of the first magnet and the second magnet in the optical axis direction.

The optical member may be disposed between the first magnet and the second magnet.

The housing wall portion may include a housing extension extending to an upper portion of the holder.

The housing may include a first member disposed at one side thereof, the mover may include a second member passing through the first member, the tilting guide part may be disposed between the first member and the mover, and a gap between the first member and the second member may be greater than a gap between the holder and the housing extension.

The housing wall portion may not overlap the first magnetic body, the second magnetic body, and the second member in the optical axis direction.

A gap between the first member and the second member facing each other in a direction perpendicular to the optical axis direction may be greater than a gap between an upper surface of the holder and a lower surface of the housing extension.

The tilting guide part may include a plurality of first protrusions spaced apart from each other in a first direction and a plurality of second protrusions spaced apart from each other in a second direction perpendicular to the first direction.

The mover may include a plurality of first protrusion grooves in which the plurality of second protrusions are disposed, and the housing may include a plurality of second protrusion grooves in which the plurality of first protrusions are disposed.

At least one of the plurality of first protrusion grooves may include an odd number of inclined surfaces, and a first boundary surface between adjacent inclined surfaces among the odd number of inclined surfaces may be bisected by a plane perpendicular to the first direction.

One of the odd number of inclined surfaces may be bisected by the plane perpendicular to the first direction.

At least one of the plurality of second protrusion grooves may include an odd number of inclined surfaces, and a second boundary surface between adjacent inclined surfaces among the odd number of inclined surfaces may be bisected by a plane perpendicular to the second direction.

A camera actuator according to an embodiment of the present invention includes a housing, a mover disposed in the housing and including a holder and an optical member disposed in the holder, a driving unit that moves the mover, a coupling member passing through the housing and coupled to the holder, a tilting guide part that is disposed between the housing and the mover and guides tilting of the mover, and an elastic member disposed between the coupling member and the housing, wherein the tilting guide part includes a plurality of first protrusions spaced apart from each other in a first direction and a plurality of second protrusions spaced apart from each other in a second direction perpendicular to the first direction, and the elastic member overlaps a region between the plurality of first protrusions and/or a region between the plurality of second protrusions in a third direction perpendicular to the first and second directions so that the tilting guide part presses the mover. The mover may rotate about the first direction based on the first protrusion or rotate about the second direction based on the second protrusion.

The plurality of second protrusions may be located between the plurality of first protrusions and the elastic member.

At least some of the plurality of second protrusions may not overlap the elastic member in the third direction.

At least a portion of the elastic member may not overlap the plurality of first protrusions in the third direction.

The coupling member may include a member base portion, a first extension extending from one end of the member base portion toward the holder, and a second extension extending from the other end of the member base portion toward the holder.

The coupling member may include a first groove disposed in an inner surface of the member base portion, and the elastic member may be disposed in the first groove.

The housing may include a housing side portion facing the member base portion, and the housing side portion may include a first through-hole and a second through-hole.

The first extension may pass through the first through-hole, and the second extension may pass through the second through-hole.

The first groove may be disposed between the first through-hole and the second through-hole and may overlap the first through-hole and the second through-hole in the second direction.

The housing side portion may include a second groove facing the first groove, and the elastic member may be disposed in the second groove.

The second groove may be located in a region between the plurality of second protrusions and disposed to be misaligned with the plurality of second protrusions in the second direction.

At least a portion of the first groove may be misaligned with the second groove in the third direction.

The first groove and the second groove may overlap each other in the third direction.

Separation distances between the plurality of second protrusions and the elastic member in the second direction may be the same.

### Advantageous Effects

According to embodiments of the present invention, a camera actuator and a camera module of which reliability is improved due to shock absorption occurring during driving of an OIS are implemented.

In addition, according to embodiments of the present invention, it is possible to implement a camera actuator and a camera module capable of easily preventing the introduction of foreign substances.

In addition, according to embodiments of the present invention, it is possible to implement a camera actuator and a camera module capable of suppressing a phenomenon in which a contact point is changed by a deviation of dimensions by deforming the shape of a protrusion groove and improving seating stability.

In addition, according to embodiments, it is possible to implement a camera actuator and a camera module capable of achieving design easiness and suppressing the generation of an electromagnetic force by pressing a tilting guide part through an elastic member.

In addition, according to embodiments of the present invention, it is possible to implement a camera actuator and a camera module of which driving efficiency and balance are improved by adjusting a location of an elastic member.

According to the present disclosure, it is possible to implement a camera actuator applicable to ultra-slim, ultra-small, and high-resolution cameras.

Various and beneficial advantages and effects of the present invention are not limited to the above-described contents and will be more readily understood during a process of describing specific embodiments of the present invention.

### DESCRIPTION OF DRAWINGS

FIG. 1 is a perspective view of a camera module according to an embodiment.

FIG. 2 is an exploded perspective view of the camera module according to the embodiment.

FIG. 3 is a view along line AA′ in FIG. 1.

FIG. 4 is a perspective view of a first camera actuator according to the embodiment.

FIG. 5 is an exploded perspective view of the first camera actuator according to the embodiment.

FIG. 6A is a perspective view of a housing of the first camera actuator according to the embodiment.

FIG. 6B is a perspective view in a different direction from FIG. 6A.

FIG. 6C is a front view of the housing of the first camera actuator according to the embodiment.

FIG. 6D is a rear view of the housing of the first camera actuator according to the embodiment.

FIG. 6E is a top view of the housing of the first camera actuator according to the embodiment.

FIG. 7 is a perspective view of an optical member of the first camera actuator according to the embodiment.

FIG. 8A is a perspective view of a holder of the first camera actuator according to the embodiment.

FIG. 8B is a bottom view of the holder of the first camera actuator according to the embodiment.

FIG. 8C is a front view of the holder of the first camera actuator according to the embodiment.

FIG. 8D is a rear view of a second member of the first camera actuator according to the embodiment.

FIG. 8E is a bottom view of the second member of the first camera actuator according to the embodiment.

FIG. 9A is a perspective view of a tilting guide part of the first camera actuator according to the embodiment.

FIG. 9B is a perspective view in a different direction from FIG. 9A.

FIG. 9C is a view along line FF′ in FIG. 9A.

FIG. 10 is a view illustrating a first driving unit of the first camera actuator according to the embodiment.

FIG. 11A is a perspective view of the first camera actuator according to the embodiment.

FIG. 11B is a view along line PP′ in FIG. 11A.

FIG. 11C is a view along line QQ′ in FIG. 11A.

FIG. 11D is a rear view of the first camera actuator according to the embodiment.

FIG. 11E is a top view of the first camera actuator according to the embodiment.

FIG. 12A is a perspective view of the first camera actuator according to the embodiment.

FIG. 12B is a view along line SS′ in FIG. 12A.

FIG. 12C is an exemplary view of movement of the first camera actuator illustrated in FIG. 12B.

FIG. 13A is a view along line RR′ in FIG. 12A.

FIG. 13B is an exemplary view of movement of the first camera actuator illustrated in FIG. 13A.

FIG. 13C is a view illustrating a collision of a housing wall portion with respect to the movement of the first camera actuator illustrated in FIG. 13A.

FIG. 14 is a perspective view illustrating the holder and the tilting guide part in the first camera actuator according to the embodiment.

FIG. 15 is a side view illustrating the holder and the tilting guide part in the first camera actuator according to the embodiment.

FIG. 16 is a top view of a housing, a first member, and the tilting guide part in the first camera actuator according to the embodiment.

FIG. 17 is a side view of the first member and the tilting guide part in the first camera actuator according to the embodiment.

FIG. 18 is an exploded perspective view of a first camera actuator according to another embodiment.

FIG. 19 is a front view of a housing of the first camera actuator according to another embodiment.

FIG. 20 is one cross-sectional view of the first camera actuator according to another embodiment.

FIG. 21 is another cross-sectional view of the first camera actuator according to another embodiment.

FIG. 22 is still another cross-sectional view of the first camera actuator according to another embodiment.

FIG. 23 is an exemplary view of movement of the first camera actuator illustrated in FIG. 22.

FIG. 24 is yet another cross-sectional view of the first camera actuator according to another embodiment.

FIG. 25 is an exemplary view of movement of the first camera actuator illustrated in FIG. 24.

FIG. 26 is a side view of the holder and an elastic member in the first camera actuator according to the embodiment.

FIG. 27 is a side view of the tilting guide part and the elastic member in the first camera actuator according to the embodiment.

FIG. 28 is a partially enlarged view of FIG. 24.

FIG. 29 is a cross-sectional view of a first camera actuator according to still another embodiment.

FIG. 30 is a cross-sectional view of a first camera actuator according to yet another embodiment.

FIG. 31 is a perspective view of a second camera actuator according to the embodiment.

FIG. 32 is a view along line DD′ in FIG. 31.

FIG. 33 is a schematic view illustrating a circuit board according to the embodiment.

FIG. 34 is a perspective view of a mobile terminal to which the camera module according to the embodiment is applied.

FIG. 35 is a perspective view of a vehicle to which the camera module according to the embodiment is applied.

### MODES OF THE INVENTION

Since the present invention may have various changes and various embodiments, specific embodiments are illustrated and described in the accompanying drawings. However, it should be understood that it is not intended to limit specific embodiments, and it should be understood to include all modifications, equivalents, and substitutes included in the spirit and scope of the present invention.

Terms including ordinal numbers such as second or first may be used to describe various components, but the components are not limited by the terms. The terms are used only for the purpose of distinguishing one component from another. For example, a second component may be referred to as a first component, and similarly, the first component may also be referred to as the second component without departing from the scope of the present invention. The term “and/or” includes a combination of a plurality of related listed items or any of the plurality of related listed items.

When a first component is described as being “connected” or “coupled” to a second component, it should be understood that the first component may be directly connected or coupled to the second component or a third component may be present therebetween. On the other hand, when a certain component is described as being “directly connected” or “directly coupled” to another component, it should be understood that still another component is not present therebetween.

Terms used in the present application are only used to describe specific embodiments and are not intended to limit the present invention. The singular includes the plural unless the context clearly dictates otherwise. In the application, it should be understood that terms “include” and “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Unless defined otherwise, all terms used herein, including technical or scientific terms, have the same meaning as commonly understood by those of ordinary skill in the art to which the present invention pertains. Terms such as those defined in a commonly used dictionary should be construed as having a meaning consistent with the meaning in the context of the related art and should not be construed in an ideal or excessively formal meaning unless explicitly defined in the application.

Hereinafter, embodiments will be described in detail with reference to the accompanying drawings, and the same or corresponding components are denoted by the same reference numeral regardless of the reference numerals, and overlapping descriptions thereof will be omitted.

In addition, in the present specification, the camera actuator is a device that moves a lens, but will be described as including both concepts including or not including a lens. Hereinafter, each of the first and second camera actuators will be described as the concept including a lens. In addition, the camera actuator that moves a lens may also be referred to as a “lens moving device,” a “lens driving device,” etc.

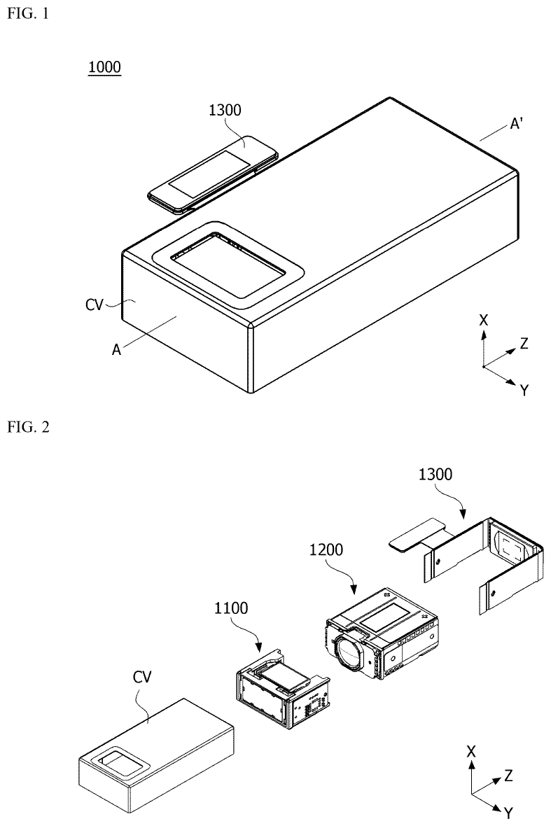

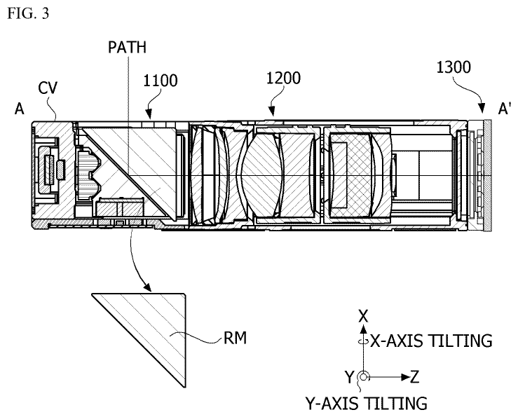

FIG. 1 is a perspective view of a camera module according to an embodiment, FIG. 2 is an exploded perspective view of the camera module according to the embodiment, and FIG. 3 is a cross-sectional view along line AA′ in FIG. 1.

Referring to FIGS. 1 and 2, a camera module 1000 according to the embodiment may include a cover CV, a first camera actuator 1100, a second camera actuator 1200, and a circuit board 1300. Here, the first camera actuator 1100 may be used interchangeably with a “first actuator,” and the second camera actuator 1200 may be used interchangeably with a “second actuator.”

The cover CV may cover the first camera actuator 1100 and the second camera actuator 1200. It is possible to increase a coupling force between the first camera actuator 1100 and the second camera actuator 1200 by the cover CV.

Furthermore, the cover CV may be formed of a material that blocks electromagnetic waves. Accordingly, it is possible to easily protect the first camera actuator 1100 and the second camera actuator 1200 in the cover CV.

In addition, the first camera actuator 1100 may be an optical image stabilizer (OIS) actuator. For example, the first camera actuator 1100 may move an optical member in a direction perpendicular to the optical axis (axis of incident light).

The first camera actuator 1100 may include a fixed focal length lens disposed in a predetermined barrel (not illustrated). The fixed focal length lens may be referred to as “single focal length lens” or “single lens.”

The first camera actuator 1100 may change an optical path. In an embodiment, the first camera actuator 1100 may vertically change the optical path through an internal optical member (e.g., a prism or a mirror). For example, the optical member may change light from a first direction (an X-axis direction) to a third direction (a Z-axis direction). With this configuration, even when a thickness of a mobile terminal is decreased, a lens with a focal length that is greater than the thickness of the mobile terminal is disposed in the mobile terminal through a change in the optical path so that magnification and auto focusing (AF), zooming, and OIS functions may be performed.

However, the embodiments of the present invention are not limited thereto, and the first camera actuator 1100 may change the optical path vertically or at a predetermined angle multiple times.

The second camera actuator 1200 may be disposed behind the first camera actuator 1100. The second camera actuator 1200 may be coupled to the first camera actuator 1100. In addition, mutual coupling may be performed by various methods.

In addition, the second camera actuator 1200 may be a zoom actuator or an AF actuator. For example, the second camera actuator 1200 may support one lens or a plurality of lenses and perform an AF function or a zooming function by moving the lenses according to a predetermined control signal of a control unit.

In addition, one lens or a plurality of lens may independently or individually move in an optical axis direction.

The circuit board 1300 may be disposed behind the second camera actuator 1200. The circuit board 1300 may be electrically connected to the second camera actuator 1200 and the first camera actuator 1100. In addition, the circuit board 1300 may be provided as a plurality of circuit boards.

A camera module according to the embodiment may be formed of one camera module or a plurality of camera modules. For example, the plurality of camera modules may include a first camera module and a second camera module.

In addition, a single camera module may include one actuator or a plurality of actuators. For example, the single camera module may include the first camera actuator 1100 and the second camera actuator 1200. Furthermore, the camera module may be used interchangeably with various terms, such as a camera device, an imaging device, etc.

In addition, the camera module may include an actuator (not illustrated) that is disposed in a predetermined housing (not illustrated) and may drive a lens part. The actuator may be a voice coil motor, a micro actuator, a silicone actuator, etc. and applied in various methods, such as an electrostatic method, a thermal method, a bimorph method, an electrostatic force method, etc., but is not limited thereto. In addition, in the present specification, the camera actuator may be referred to as “actuator” or the like. In addition, the camera module formed of the plurality of camera modules may be mounted in various electronic devices, such as a mobile terminal. Furthermore, the actuator may be a device for moving or tilting the lens or the optical member. However, the actuator will be described below as including the lens or the optical member. Furthermore, the actuator may be referred to as “lens transfer device,” “lens moving device,” “optical member transfer device,” “optical member moving device,” etc.

Referring to FIG. 3, the camera module according to the embodiment may include the first camera actuator 1100 for performing the OIS function and the second camera actuator 1200 for performing the zooming function and the AF function.

Light may enter the camera module or the first camera actuator through an opening region located at an upper surface of the first camera actuator 1100. That is, the light may be incident on the first camera actuator 1100 in an optical axis direction (e.g., an X-axis direction, based on incident light), and the optical path may be changed in a vertical direction through the optical member. In addition, the light may pass through the second camera actuator 1200 and may be incident on an image sensor IS located at one end of the second camera actuator 1200 (PATH). In the present specification, the Z-axis direction or a third direction will be described as the optical axis direction below. In addition, in the present specification, the optical axis direction corresponds to the third direction, the vertical direction corresponds to the first direction, and the horizontal direction corresponds to the second direction.

In the present specification, a lower surface refers to one side in a first direction. In addition, the first direction is the X-axis direction in the drawings and may be used interchangeably with a second axis direction. A second direction is a Y-axis direction in the drawings and may be used interchangeably with a first axis direction. The second direction is a direction perpendicular to the first direction. In addition, the third direction is the Z-axis direction in the drawings and may be used interchangeably with a third axis direction. In addition, the third direction is a direction perpendicular to both the first direction and the second direction. Here, the third direction (the Z-axis direction) corresponds to the optical axis direction, and the first direction (the X-axis direction) and the second direction (the Y-axis direction) are directions perpendicular to the optical axis. In addition, hereinafter, the optical axis direction in the description of the first camera actuator and the second camera actuator is a third direction (the Z-axis direction), and based on the above description, the following description will be given.

In addition, in the present specification, “inside” may be a direction from the cover CV to the first camera actuator, and “outside” may be a direction opposite to “inside.” For example, the first camera actuator and the second camera actuator may be located inside the cover CV, and the cover CV may be located outside the first camera actuator or the second camera actuator.

The camera module according to the embodiment may resolve the spatial limitations of the first camera actuator and the second camera actuator by changing the optical path. The camera module according to the embodiment may extend the optical path while minimizing the thickness of the camera module in response to the change in the optical path. Furthermore, it should be understood that the second camera actuator may provide a high range of magnification by controlling a focus in the extended optical path.

In addition, the camera module according to the embodiment may implement an OIS by controlling the optical path through the first camera actuator, thereby minimizing the occurrence of a decentering or tilting phenomenon and providing the best optical characteristics.

Furthermore, the second camera actuator 1200 may include an optical system and a lens driving unit. For example, at least one of a first lens assembly, a second lens assembly, and a third lens assembly may be disposed in the second camera actuator 1200.

In addition, the second camera actuator 1200 may include a coil and a magnet and perform a high-magnification zooming function and the AF function.

For example, although the first lens assembly and the second lens assembly may be moving lenses that move through the coil, the magnet, and a guide pin and the third lens assembly may be a fixed lens, the embodiments of the present invention are not limited thereto. For example, the third lens assembly may perform a function of a focator using which light forms an image at a specific location and may be in a state of having a big change in magnification due to a big change in distance or phase distance to a subject according to the movement of the first lens assembly. In addition, the first lens assembly, which is a variator, may play an important role in changing the focal length or magnification of the optical system. Meanwhile, imaging points of an image formed by the first lens assembly, which is the variator, may be slightly different depending on a location thereof. Accordingly, the second lens assembly may perform a location compensation function for the image formed by the variator. For example, the second lens assembly may perform a function of a compensator for accurately forming an image at an actual location of the image sensor using the imaging points of the image formed by the first lens assembly which is the variator.

In addition, the first lens assembly and the second lens assembly may be driven by an electromagnetic force generated by interaction between the coil and the magnet. The above description may be applied to a lens assembly to be described below. In addition, the first lens assembly and the second lens assembly may move in the optical axis direction, that is, in the third direction. In addition, the first lens assembly and the second lens assembly may move independently or dependently in the third direction.

Furthermore, the third lens assembly may be located in front of the first lens assembly or behind the second lens assembly. That is, the third lens assembly may be located adjacent to the first camera actuator or adjacent to the image sensor. In addition, the third lens assembly may be fixed.

In the present invention, the first lens assembly and the second lens assembly may move in the optical axis direction. In addition, the third lens assembly may be located in front of the first lens assembly or at behind the second lens assembly. In addition, the third lens assembly may not move in the optical axis direction. That is, the third lens assembly may be a fixed part. In addition, the first and second lens assemblies may be moving parts.

Meanwhile, when the OIS actuator and the AF/zoom actuator are disposed according to the embodiment of the present invention, the magnetic field interference with AF/zoom magnets can be prevented when the OIS is driven. Since a magnet of the first camera actuator 1100 is disposed separately from the second camera actuator 1200, it is possible to prevent magnetic interference between the first camera actuator 1100 and the second camera actuator 1200. In the present specification, an OIS may be used interchangeably with terms, such as hand shaking correction, optical image stabilization, optical image correction, shaking correction, etc.

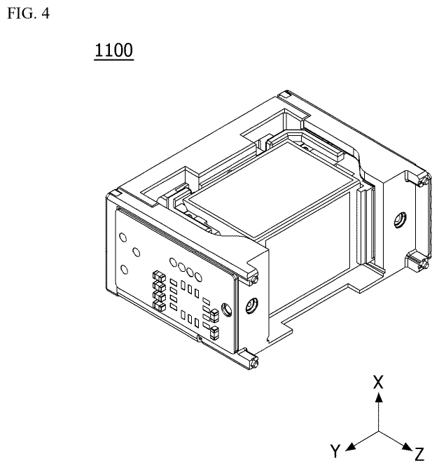

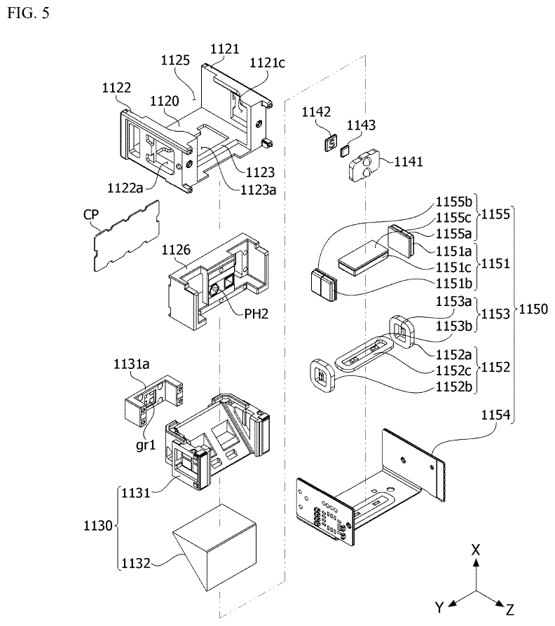

FIG. 4 is an exploded perspective view of the first camera actuator according to the embodiment, and FIG. 5 is an exploded perspective view of the first camera actuator according to the embodiment.

Referring to FIGS. 4 and 5, the first camera actuator 1100 according to the embodiment may include a housing 1120, a mover 1130, a rotating part 1140, a driving unit 1150, a first member 1126, and a second member 1131a. Furthermore, the first camera actuator 1100 may further include a plate CP. The first member 1126 may be referred to as a “sixth housing side portion,” an “additional housing side portion,” a “housing rigid,” etc. The second member 1131a may be referred to as a “mover rigid,” a “coupling member,” etc.

The mover 1130 may include a holder 1131 and an optical member 1132 seated on the holder 1131. The mover 1130 may be disposed between a first housing side portion 1121 and a second housing side portion 1122, which will be described below. In addition, the rotating part 1140 may include a tilting guide part 1141 and a second magnetic body 1142 and a first magnetic body 1143 having the same or different poles to press the tilting guide part 1141. For example, the first magnetic body 1143 and the second magnetic body 1142 may have facing surfaces with the same pole. In addition, the driving unit 1150 includes a driving magnet 1151, a driving coil 1152, a Hall sensor part 1153, a first substrate part 1154, and a yoke part 1155.

First, the first camera actuator 1100 may include a shield can (not illustrated). The shield can (not illustrated) may be located at an outermost side of the first camera actuator 1100 and located to surround the rotating part 1140 and the driving unit 1150, which will be described below.

The shield can (not illustrated) can block or reduce electromagnetic waves generated from the outside. That is, the shield can (not illustrated) can reduce the occurrence of malfunction in the rotating part 1140 or the driving unit 1150.

The housing 1120 may be located inside the shield can (not illustrated). When there is no shield can, the housing 1120 may be located at the outermost side of the first camera actuator.

In addition, the housing 1120 may be located inside a first substrate part 1154 to be described below. The housing 1120 may be fastened by being inserted into or engaged with the shield can (not illustrated).

The housing 1120 may include the first housing side portion 1121, the second housing side portion 1122, a third housing side portion 1123, and a housing wall portion 1124. The detailed description thereof will be given below.

The first member 1126 may be disposed in the housing 1120. The second member 1131a may pass through a portion of the first member 1126. The first member 1126 may be disposed in the housing. The first member 1126 may be a structure that is formed integrally with or separated from the housing 1120.

Furthermore, the first camera actuator 1100 may further include the plate CP disposed at an outer side of the first member 1126. The plate CP can prevent foreign substances from flowing into the second member 1131a passing through the first member 1126. Furthermore, the plate CP may be formed of a magnetic material. Accordingly, since the plate CP has magnetism, a magnetic force may not be generated by the first magnetic body 1143 and the second magnetic body 1142 having poles for pressing. That is, it is possible to reduce generation of magnetic forces that interfere with the driving (pressing) of the first magnetic body 1143 and the second magnetic body 1142. When the plate CP is the magnetic body, the plate CP may be referred to as a magnetic member, a magnetic body, a cover plate, a metal member, a metal plate, etc. In addition, the plate CP may be formed of a non-magnetic material for lightweight and low cost.

The mover 1130 includes the holder 1131 and the optical member 1132 seated on the holder 1131.

The holder 1131 may be seated in an accommodation part 1125 of the housing 1120. The holder 1131 may include a first holder outer surface to a fourth holder outer surface corresponding to the first housing side portion 1121, the second housing side portion 1122, the third housing side portion 1123, and the first member 1126, respectively. For example, the first holder outer surface to the fourth holder outer surface may correspond to or face inner surfaces of the first housing side portion 1121, the second housing side portion 1122, the third housing side portion 1123, and the first member 1126, respectively.

In addition, the holder 1131 may include the second member 1131a disposed in a fourth seating groove. The second member 1131a may be coupled to the holder 1131 after passing through the first member 1126. The second member 1131a and the holder 1131 may be coupled by various bonding members or coupling members. The detailed description thereof will be given below.

The optical member 1132 may be seated on the holder 1131. To this end, the holder 1131 may have a seating surface, and the seating surface may be formed by an accommodation groove. In an embodiment, the optical member 1132 may be composed of a mirror or a prism. Hereinafter, the optical member 1132 is illustrated as being a prism, but may be formed of a plurality of lenses as in the above embodiment. Alternatively, the optical member 1132 may be composed of the plurality of lenses and a prism or a mirror. In addition, the optical member 1132 may include a reflector disposed therein. However, the embodiments of the present invention are not limited thereto.

In addition, the optical member 1132 may reflect light reflected from the outside (e.g., an object) into the camera module. That is, the optical member 1132 can resolve the spatial limitations of the first camera actuator and the second camera actuator by changing the path of the reflected light. Accordingly, it should be understood that the camera module may provide a high range of magnification by extending the optical path while minimizing a thickness thereof.

Additionally, the second member 1131a may be coupled to the holder 1131. The second member 1131a may be disposed outside the holder 1131 and inside the housing. In addition, the second member 1131a may be seated in an additional groove located in a region of the fourth holder outer surface of the holder 1131, which excludes the fourth seating groove. Accordingly, the second member 1131a may be coupled to the holder 1131, and at least a portion of the first member 1126 may be located between the second member 1131a and the holder 1131. For example, the at least a portion of the first member 1126 may be disposed in a space formed between the second member 1131a and the holder 1131. In addition, as described above, the second member 1131a may pass through-holes (a first through-hole and a second through-hole, which will be described below) formed in the first member 1126.

In addition, the second member 1131a may have a structure separated from the holder 1131. With this configuration, the first camera actuator can be easily assembled as will be described below. Alternatively, the second member 1131a may be formed integrally with the holder 1131, but will be described below as having the separated structure.

The rotating part 1140 includes the tilting guide part 1141 and the second magnetic body 1142 and the first magnetic body 1143 having the same pole to press the tilting guide part 1141.

The tilting guide part 1141 may be coupled to the mover 1130 and the housing 1120. Specifically, the tilting guide part 1141 may be disposed between the holder 1131 and the first member 1126. Accordingly, the tilting guide part 1141 may be coupled to the mover 1130 of the holder 1131 and the housing 1120. However, unlike the above description, in the present embodiment, the tilting guide part 1141 may be disposed between the first member 1126 and the holder 1131. Specifically, the tilting guide part 1141 may be located between the first member 1126 and the fourth seating groove of the holder 1131. For example, at least a portion of the tilting guide part 1141 may be located at the fourth seating groove.

The second member 1131a, the first member 1126, the tilting guide part 1141, and the holder 1131 may be sequentially disposed in the third direction (the Z-axis direction). In addition, the second magnetic body 1142 and the first magnetic body 1143 may be respectively seated in a first groove gr1 formed in the second member 1131a and a second groove gr2 formed in the first member 1126. However, the first groove gr1 is located at the second member 1131a and moves integrally with the holder and the second member 1131a, and the second groove is located at the first member 1126 corresponding to the first groove gr1 and coupled to the housing 1120. Accordingly, the following description will be given by interchangeably using these terms. Furthermore, the first groove and the second groove may be grooves as described above. Alternatively, the first groove and the second groove may be replaced with the form of a hole.

In addition, the tilting guide part 1141 may be disposed adjacent to the optical axis. Accordingly, the actuator according to the embodiment can easily change the optical path according to first-axis tilting and second-axis tilting, which will be described below.

The tilting guide part 1141 may include first protrusions disposed to be spaced apart from each other in the first direction (the X-axis direction) and second protrusions disposed to be spaced apart from each other in the second direction (the Y-axis direction). In addition, the first protrusion and the second protrusion may protrude in opposite directions. The detailed description thereof will be given below.

In addition, as described above, the second magnetic body 1142 may be located at the second member 1131a. In addition, the first magnetic body 1143 may be located at the first member 1126.

The second magnetic body 1142 and the first magnetic body 1143 may have the same pole. For example, the second magnetic body 1142 may be a magnet having an N pole, and the first magnetic body 1143 may be a magnet having an N pole. Alternatively, the second magnetic body 1142 may be a magnet having an S pole, and the first magnetic body 1143 may be a magnet having an S pole. For example, as described above, a first pole surface of the first magnetic body 1143 and a second pole surface of the second magnetic body 1142, which faces the first pole surface, may have the same pole.

The second magnetic body 1142 and the first magnetic body 1143 may generate a repulsive force therebetween due to the above poles. With this configuration, the repulsive force may be applied to the second member 1131a or the holder 1131 coupled to the second magnetic body 1142 and the first member 1126 or the housing 1120 coupled to the first magnetic body 1143. In this case, the repulsive force applied to the second member 1131a may be transmitted to the holder 1131 coupled to the second member 1131a. Accordingly, the tilting guide part 1141 disposed between the second member 1131a and the first member 1126 may be pressed by the repulsive force. Furthermore, the repulsive force may also be transmitted to the housing and the mover. Accordingly, the housing and the mover may be pressed by the repulsive force. That is, the repulsive force may correspond to a holding force that holds a location between the housing and the mover. That is, the repulsive force may maintain the location of the tilting guide part 1141 between the holder 1131 and the housing 1120 (or the first member 1126). With this configuration, the location between the mover 1130 and the housing 1120 may be maintained even during X-axis tilting or Y-axis tilting. In addition, the tilting guide part may be in close contact with the first member 1126 and the holder 1131 by the repulsive force between the first magnetic body 1143 and the second magnetic body 1142. That is, the repulsive force generated by the first magnetic body 1143 and the second magnetic body 1142 may be a holding force for the location between the holder 1131 and the housing 1120.

The driving unit 1150 includes the driving magnet 1151, the driving coil 1152, the Hall sensor part 1153, the first substrate part 1154, and the yoke part 1155. The descriptions thereof will be given below.

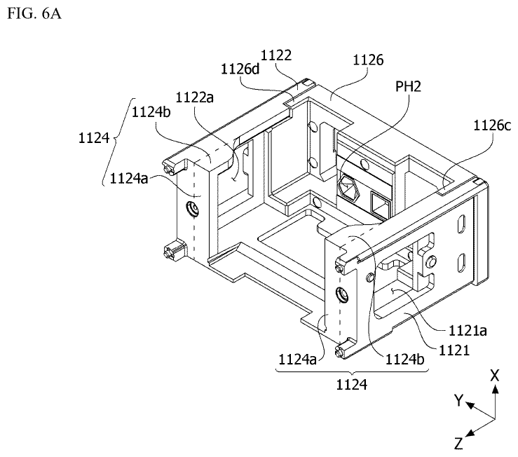

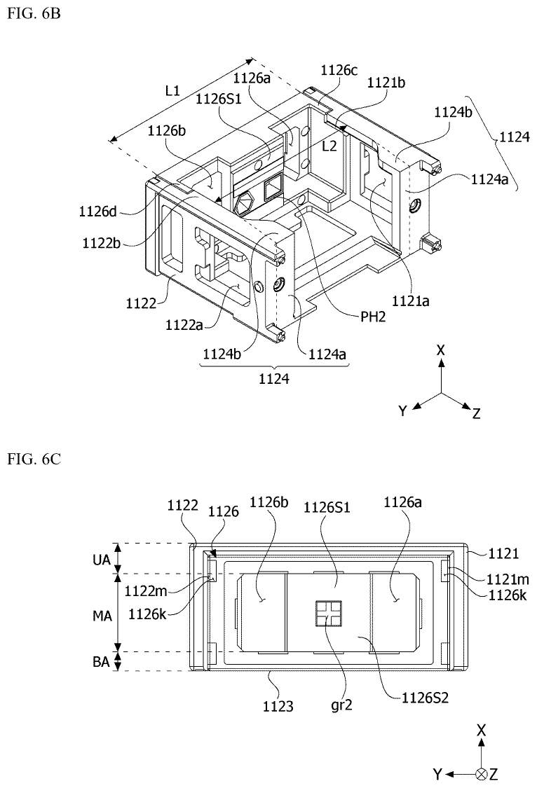

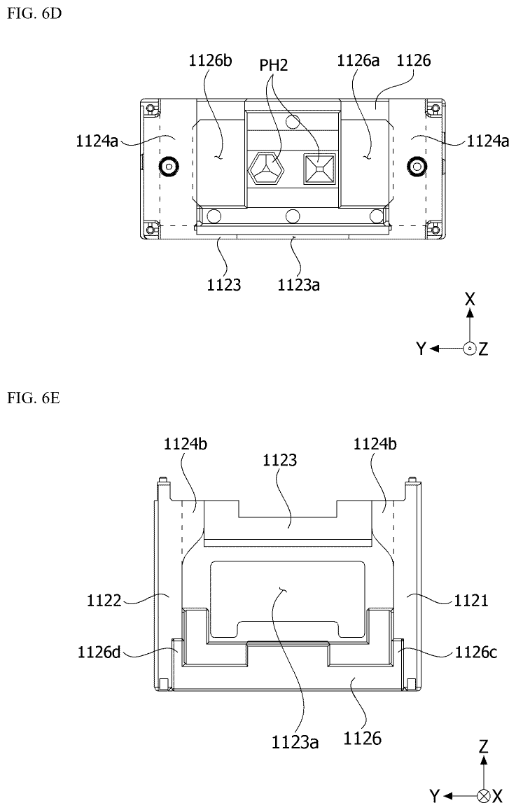

FIG. 6A is a perspective view of a housing of the first camera actuator according to the embodiment, FIG. 6B is a perspective view in a different direction from FIG. 6A, FIG. 6C is a front view of the housing of the first camera actuator according to the embodiment, FIG. 6D is a rear view of the housing of the first camera actuator according to the embodiment, and FIG. 6E is a top view of the housing of the first camera actuator according to the embodiment.

Referring to FIGS. 6A to 6E, the housing 1120 according to the embodiment may include the first housing side portion 1121 to the third housing side portion 1123. In addition, the first member 1126 may be coupled integrally to the housing 1120. Accordingly, the first member 1126 may be a component included in the housing 1120. Alternatively, the housing 1120 may include the first member 1126. However, the first member 1126 will be described below as having a structure that is separated from the housing 1120.

The first housing side portion 1121 and the second housing side portion 1122 may be disposed to face each other. In addition, the first member 1126 and the housing wall portion 1124 may be disposed to face each other. Furthermore, the housing wall portion 1124 may also be applied to a structure of a camera actuator in which the first member and the second member do not exist in the same manner. That is, even in a structure in which the mover is tilted in the housing, a fixed housing may include the housing wall portion.

In addition, the third housing side portion 1123 may be disposed between the first housing side portion 1121 and the second housing side portion 1122.

The third housing side portion 1123 may be in contact with the first housing side portion 1121 and the second housing side portion 1122. In addition, the third housing side portion 1123 may be a lower surface of the housing 1120. In addition, the above contents may also be applied to the description of a direction in the same manner.

In addition, the first housing side portion 1121 may include a housing hole 1121a. A first coil to be described below may be located at the housing hole 1121a.

In addition, the second housing side portion 1122 may include a second housing hole 1122a. In addition, the second coil 1152b to be described below may be located at the second housing hole 1122a.

In addition, the first housing side portion 1121 and the second housing side portion 1122 may be side surfaces of the housing 1120.

The first coil and the second coil may be coupled to a first board part. In an embodiment, the first coil and the second coil may be electrically connected to the first board part to allow a current to flow therethrough. The current is an element of an electromagnetic force capable of tilting the second camera actuator with respect to an X-axis.

In addition, the third housing side portion 1123 may include a third housing hole 1123a.

A third coil to be described below may be located at the third housing hole 1123a. In addition, the third coil 1152c may be electrically connected and coupled to the first substrate part in contact with the housing 1120. Accordingly, the third coil may be electrically connected to the first board part to receive a current from the first board part. The current is an element of an electromagnetic force capable of tilting the second camera actuator with respect to a Y-axis.

The first member 1126 may be seated between the first housing side portion 1121 to the third housing side portion 1123. Accordingly, the first member 1126 may be located at the third housing side portion 1123. For example, the first member 1126 may be located at one side of the third housing side portion 1123. The first member 1126 and the holder may be sequentially located in the third direction.

In addition, the housing 1120 may include the accommodation part 1125 formed by the first housing side portion 1121 to the third housing side portion 1123. The first member 1126, the second member 1131a, and the mover 1130 may be located at the accommodation part 1125 as components. The mover, the tilting guide, and the like may be located at the accommodation part 1125.

In addition, the housing 1120 may further include the housing wall portion 1124 facing the first member 1126. In addition, the housing wall portion 1124 may be disposed between the first housing side portion 1121 and the second housing side portion 1122 and may be in contact with the first housing side portion 1121, the second housing side portion 1122, and the third housing side portion 1123.

In addition, the housing wall portion 1124 may be located at ends of the first housing side portion 1121 and the second housing side portion 1122. In addition, the housing wall portion 1124 may extend from the first housing side portion 1121 and the second housing side portion 1122 and overlap at least a portion of the holder in the optical axis direction.

The housing wall portion 1124 may be provided as a plurality of housing wall portions. In addition, the plurality of housing wall portions 1124 may be located in contact with the first housing side portion 1121 and the second housing side portion 1122. The plurality of housing wall portions 1124 may be spaced apart from each other in the second direction (the Y-axis direction). Accordingly, the light reflected from the optical member 1132 through a separation region may move to the second camera actuator located behind the camera module. That is, the separation region provides a path for light to move.

In addition, the housing wall portion 1124 may include protrusions, grooves, etc. to provide easy coupling with another camera actuator (the second camera actuator) adjacent thereto. With this configuration, it is possible to increase a coupling force between the housing wall portion 1124 having an opening providing the optical path and another component while providing the optical path, thereby suppressing movement of the opening due to separation and minimizing a change in optical path.

More specifically, the housing wall portion 1124 may be disposed on a side portion corresponding to an exit surface of the optical member. In addition, the housing wall portion 1124 may be located between the first housing side portion 1121 and the second housing side portion 1122 and located at the ends of the first housing side portion 1121 and the second housing side portion 1122 in the optical axis direction. In addition, the housing wall portion 1124 may be disposed at a location at which the mover partially overlaps in the optical axis direction. Accordingly, the housing wall portion 1124 may be located at a rear end of the accommodation part 1125 in the optical axis direction. Furthermore, the housing wall portion 1124 may be located at a rear end of the optical member in the optical axis direction (the Z-axis direction).

In addition, the housing wall portion 1124 may overlap the holder in the optical axis direction (the Z-axis direction). In addition, at least a portion of the housing wall portion 1124 may overlap the holder in the optical axis direction. In addition, the housing wall portion 1124 may be disposed to be spaced apart from the holder in the optical axis direction. The housing wall portion 1124 may be disposed to be spaced apart from an exit surface of the optical member, that is, the optical member, in the optical axis direction. In addition, the housing wall portion 1124 may be disposed on a side portion corresponding to the light-emitting surface of the optical member. Here, the optical axis direction (the Z-axis direction) may correspond to a moving direction of the reflected light. In addition, the optical axis direction may correspond to a direction perpendicular to the light-emitting surface of the optical member. Accordingly, for a hand-shake prevention function, even when the mover, that is, the holder tilts, a movement amount may be limited by the housing wall portion 1124. Furthermore, the housing wall portion 1124 and the holder may collide with each other so that no shock occurs in the first member or the second member. Accordingly, it is possible to improve the reliability of the first member and the second member.

In addition, the housing wall portion 1124 may be formed integrally with the housing 1120. In addition, a portion of the housing wall portion 1124 may be formed of an elastic material. In addition, an elastic member may be additionally disposed on the housing wall portion 1124. For example, an elastic material or shock absorption member for shock absorption may be located at an inner surface of the housing wall portion 1124. Accordingly, it is possible to reduce a shock applied to the holder 1131 due to a collision between the housing wall portion 1124 and the holder 1131.

In addition, the housing wall portion 1124 according to the embodiment may include a wall 1124a facing (or corresponding to) the rear surface of the holder (or the light-emitting surface of the optical member) and a housing extension 1124b extending from the wall 1124a to an upper portion of the holder.

The wall 1124a may overlap the holder in the optical axis direction (the Z-axis direction). In addition, the housing extension 1124b may overlap the holder in the first direction.

The wall 1124a may serve as a stopper against the tilting of the holder in the first direction or the second direction. That is, when the holder tilts, the holder and the wall 1124a may collide with or come into contact with each other.

In addition, when the holder moves in the first direction or performs second-axis tilting (e.g., vertical driving), the housing extension 1124b may collide with or come into contact with the holder. That is, the housing extension 1124b may serve as a stopper against the movement of the holder in the first direction. Furthermore, the third housing side portion 1123 may also perform a stopper function.

In addition, as described above, the first member 1126 may be a component that is coupled to the housing 1120 and included in the housing 1120. For example, the first member 1126 may be a structure that is integrally formed with or separated from the housing 1120. Hereinafter, the first member 1126 will be described as having a structure that is separated from the housing 1120.

In addition, the first member 1126 may be disposed on the housing 1120. Alternatively, the first member 1126 may be located in the housing 1120.

In addition, the first member 1126 may be coupled to the housing 1120. In an embodiment, the first member 1126 may be located between the first housing side portion 1121 and the second housing side portion 1122. In addition, the first member 1126 may be located at the third housing side portion 1123 and may be in contact with the first housing side portion to the third housing side portion.

In addition, a first stop member 1121b may be located at an inner surface of the first housing side portion 1121. In addition, a second stop member 1122b may be located at an inner surface of the second housing side portion 1122.

The first stop member 1121b and the second stop member 1122b may be symmetrically located with respect to the first direction (the X-axis direction). The first stop member 1121b and the second stop member 1122b may extend in the first direction (the X-axis direction). With this configuration, even when the first member 1126 moves into the housing 1120, a location of the first member 1126 may be maintained by the first stop member 1121b and the second stop member 1122b. That is, the first stop member 1121b and the second stop member 1122b may maintain the first member 1126 to be located at one side of the housing 1120.

Furthermore, the first stop member 1121b and the second stop member 1122b may fix the location of the first member 1126 to fix a location of the tilting guide part between the first member 1126 and the mover, thereby removing factors that cause errors such as vibrations. Accordingly, the first camera actuator according to the embodiment can accurately perform the X-axis tilting and the Y-axis tilting.

In addition, a separation distance L2 between the first stop member 1121b and the second stop member 1122b in the second direction (the Y-axis direction) may be smaller than a maximum length L1 of the first member 1126 in the second direction (the Y-axis direction). Accordingly, the first member 1126 may be assembled or inserted into the side surface of the housing 1120 and coupled to the housing 1120. Furthermore, the holder may be assembled to the housing 1120 in the first direction or the third direction. In addition, as described above, the first member 1126 may be coupled to the housing 1120 along a side surface of the housing 1120, that is, in the optical axis direction. In addition, the second member may be assembled or inserted into the housing 1120 in the optical axis direction. Accordingly, the second member may pass through the first member 1126. Thereafter, a plate may be further disposed on the first member 1126.

In addition, the first member 1126 includes a second protrusion groove PH2 in which the second protrusion of the tilting guide part is seated. The second protrusion groove PH2 may be located at an inner surface 1126S1 of the first member 1126. As will be described below, the contents of the first protrusion groove may be applied to the second protrusion groove PH2 in the same manner. For example, the second protrusion groove PH2 may be provided as a plurality of second protrusion grooves and may have a structure having contact points that are the same as or different from those of the second protrusion of the tilting guide part. For example, the number of second protrusion grooves PH2 is two, and the second protrusion groove PH2 may have a multi-point (e.g., 3-point, 4-point, etc.) contact structure. That is, the second protrusion groove PH2 may have a plurality of inclined surfaces. In addition, the second protrusion groove PH2 may also be a hemispherical groove. Description thereof will be made below.

In addition, in the first member 1126, the protrusion (e.g., the second protrusion) of the tilting guide part is disposed adjacent to the optical member (prism) in the fourth seating groove so that the protrusion, which is a reference axis of tilting, is disposed adjacent to the center of gravity of the mover 1130. Accordingly, when the holder tilts, it is possible to minimize a moment for moving the mover 1130 for tilting. Accordingly, it is also possible to minimize current consumption for driving the coil, thereby reducing the power consumption of the camera actuator.

In addition, the first member 1126 may include through-holes 1126a and 1126b. The through-hole may be provided as a plurality of through-holes and may include a first through-hole 1126a and a second through-hole 1126b.

First and second extensions of the second member, which will be described below, may pass through the first through-hole 1126a and the second through-hole 1126b, respectively. Accordingly, a holding force between the second member and the first member may be generated by the repulsive force between the first and second magnetic bodies. That is, even when the mover tilts, the location between the housing and the mover may be held.

The second protrusion groove PH2 may be located between the first through-hole 1126a and the second through-hole 1126b. With this configuration, it is possible to increase the coupling force between the tilting guide part 1141 and the first member 1126, thereby preventing a reduction in tilting accuracy caused by the movement of the tilting guide part 1141 in the housing.

In addition, the second groove gr2 may be located at an outer surface 1126S2 of the first member 1126. The first magnetic body may be seated in the second groove gr2. In addition, the outer surface 1126S2 of the first member 1126 may be opposite to or face an inner surface of the second member or a member base portion. Furthermore, the second magnetic body seated on the second member and the first magnetic body of the first member 1126 may face each other and generate the above repulsive force. Accordingly, since the first member 1126 presses the tilting guide part inward or the holder by the repulsive force, the mover may be spaced a predetermined distance from the third housing side portion in the housing even when no current is applied to the coil. That is, the holding force for holding the location between the mover, the housing, and the tilting guide part may be generated by the first magnetic body and the second magnetic body.

In addition, when the first member 1126 is formed integrally with the housing 1120, it is possible to increase the coupling force between the first member 1126 and the housing 1120, thereby improving the reliability of the camera actuator. In addition, when the first member 1126 is formed separately from the housing 1120, it is possible to improve the ease of assembling and manufacturing of the first member 1126 and the housing 1120.

In addition, in an embodiment, the first member 1126 may include the first through-hole 1126a and the second through-hole 1126b as described above. In addition, the first through-hole 1126a and the second through-hole 1126b may be disposed side by side in the second direction (the Y-axis direction) and may overlap each other.

In addition, the first member 1126 may include upper members UA located above the first through-hole 1126a and the second through-hole 1126b and bottom members BA located under the first through-hole 1126a and the second through-hole 1126b. Accordingly, the first through-hole 1126a and the second through-hole 1126b may be located in the middle of the first member 1126. That is, the first member 1126 may include connection members MA located at side portions of the first through-hole 1126a and the second through-hole 1126b. That is, the upper member UA and the bottom member BA may be connected through the connection member MA. In addition, the bottom member BA may be provided as a plurality of bottom members to form the first and second through-holes and disposed to be spaced apart from each other in the second direction (the Y-axis direction).

Accordingly, the first member 1126 may have the upper member UA, thereby increasing stiffness. For example, it is possible to increase the stiffness of the first member 1126 compared to a case in which the upper member UA does not exist. For example, in the present embodiment, a unit of stiffness may be N/μm. Accordingly, it is possible to improve the reliability of the first camera actuator according to the embodiment.

In addition, a first coupling groove 1126k may be located at the outer surface 1126S2 of the first member 1126. The first coupling groove 1126k may be located at an edge of the outer surface 1126S2 of the first member 1126. In particular, the first coupling groove 1126k may be located at an end (e.g., left and right sides) of the outer surface 1126S2 of the first member 1126 and located adjacent to the first housing side portion 1121.

The first coupling groove 1126k may be located to correspond to second coupling grooves 1121m and 1122m of the first housing side portion 1121 and the second housing side portion 1122. In an embodiment, the first coupling groove 1126k may be located to correspond to (or face) the second coupling grooves 1121m and 1122m of the first housing side portion 1121 and the second housing side portion 1122. The second coupling grooves 1121m and 1122m may be located at side surfaces that are adjacent to the outer surface 1126S2 of the first member 1126 and are the same surface.

In an embodiment, the first coupling groove 1126k and the second coupling groove 1121m and 1122m may be provided as a plurality of grooves, and the plurality of first coupling grooves 1126k and the plurality of second coupling grooves 1121m and 1122m may be located symmetrically in the first direction or the second direction.

In addition, the first coupling groove 1126k and the second coupling grooves 1121m and 1122m may be coated with bonding members. That is, the bonding member may be coated between the first housing side portion (or the second housing side portion) and the first member 1126, thereby increasing the coupling force between the housing 1120 and the first member 1126. The bonding member may include an epoxy or the like, but is not limited to such a material.

In addition, the first member 1126 may further include a first protrusion 1126c and a second protrusion 1126d. The first protrusion 1126c may be in contact with the first housing side portion 1121, and the second protrusion 1126d may be in contact with the second housing side portion 1122. The first protrusion 1126c may extend from one end of the outer surface 1126S2 of the first member in the third direction (the Z-axis direction). The second protrusion 1126d may extend from the other end of the outer surface 1126S2 of the first member in the third direction (the Z-axis direction). That is, the first protrusion and the second protrusion may extend toward the holder.

The location of the first protrusion may be maintained by the first stop member 1121b, and the location of the second protrusion may be maintained by the second stop member 1122b. Accordingly, it is possible to improve the reliability of the camera actuator according to the embodiment.

In addition, as described above, the housing wall portion 1124 according to the embodiment may include the wall 1124a and the housing extension 1124b.

The housing wall portion 1124 or the wall 1124a may overlap a first through-hole 1126a and a second through-hole 1126b of the first member 1126 in the optical axis direction (the Z axis direction). For example, parts of the housing wall portion 1124 or the wall 1124a may overlap the first through-hole 1126a and the second through-hole 1126b of the first member 1126 in the optical axis direction (the Z axis direction).

In addition, the second protrusion groove PH2 may be located between the adjacent walls 1124a. In addition, the housing wall portion 1124 or the wall 1124a may not overlap the second protrusion groove PH2 in the optical axis direction (the Z-axis direction).

With this configuration, it is possible to increase an effective region of the light emitted after being reflected through the optical member located between the adjacent walls 1124a.

Furthermore, a distance (a separation distance in the second direction) between the adjacent housing extensions 1124b may decrease in the optical axis direction. With this configuration, it is possible to increase an amount of light incident to the optical member. Furthermore, the housing extension 1124b may sufficiently serve as a stopper against the tilting of the holder.

In addition, the third housing hole 1123a may be located between the adjacent housing extensions 1124b. That is, the third housing hole 1123a and the housing extension 1124b do not overlap each other in the first direction (the X-axis direction) and may be misaligned.

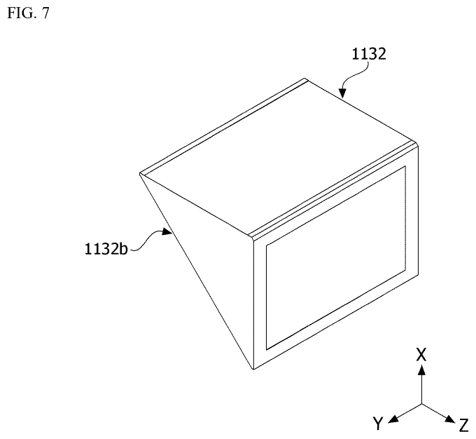

FIG. 7 is a perspective view of an optical member of the first camera actuator according to the embodiment.

The optical member 1132 may be seated on the holder. The optical member 1132 may be a right-angled prism as a reflector, but is not limited thereto.

In an embodiment, the optical member 1132 may have a protrusion (not illustrated) on a portion of an outer surface thereof. The optical member 1132 can be easily coupled to the holder through the protrusion (not illustrated). In addition, the holder may be coupled to the optical member 1132 by having a groove or a protrusion.

In addition, a lower surface 1132b of the optical member 1132 may be seated on the seating surface of the holder. Accordingly, the lower surface 1132b of the optical member 1132 may correspond to the seating surface of the holder. Furthermore, the lower surface 1132b of the optical member 1132 may be a reflective surface. In addition, an upper surface of the optical member 1132 may be an incident surface on which light is incident. In addition, a rear surface of the optical member 1132 may be an exit surface through which light exits.

In addition, in an embodiment, the lower surface 1132b may be formed of an inclined surface that is the same as the surface on which the holder is seated. Accordingly, it is possible to prevent the optical member 1132 from being separated from the holder due to the prism moving together according to the movement of the holder.

In addition, a groove may be formed in the lower surface 1132b of the optical member 1132 and the lower surface 1132b may be coated with bonding member so that the optical member 1132 may be coupled to the holder. Alternatively, the groove or the protrusion of the holder may be coated with the bonding member so that the holder may be coupled to the optical member 1132.

In addition, the protrusion of the holder may face the housing wall portion to be described below. Furthermore, the protrusion of the holder may overlap the optical member 1132 in the optical axis direction. Accordingly, in the present embodiment, the protrusion of the holder may not overlap the housing wall portion in the optical axis direction.

In addition, as described above, the optical member 1132 may have a structure capable of reflecting the light reflected from the outside (e.g., an object) into the camera module. As in the embodiment, the optical member 1132 may be formed of a single mirror. In addition, the optical member 1132 can resolve the spatial limitations of the first camera actuator and the second camera actuator by changing the path of the reflected light. Accordingly, it should be understood that the camera module may provide a high range of magnification by extending the optical path while minimizing a thickness thereof. In addition, it should be understood that the camera module including the camera actuator according to the embodiment may provide a high range of magnification by extending the optical path while minimizing the thickness thereof.

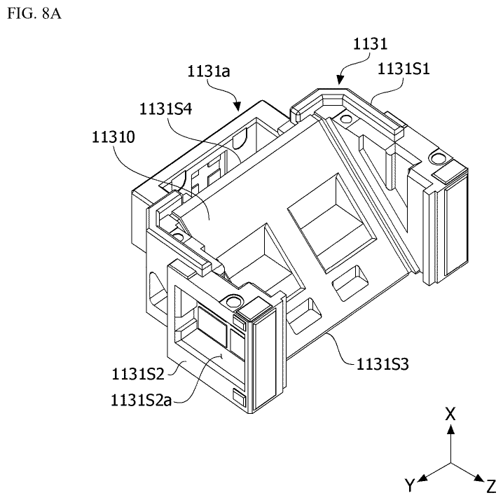

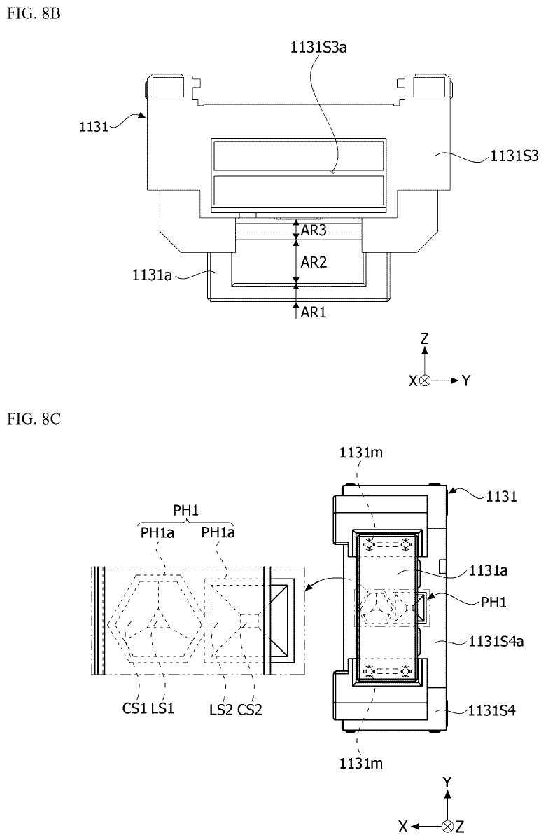

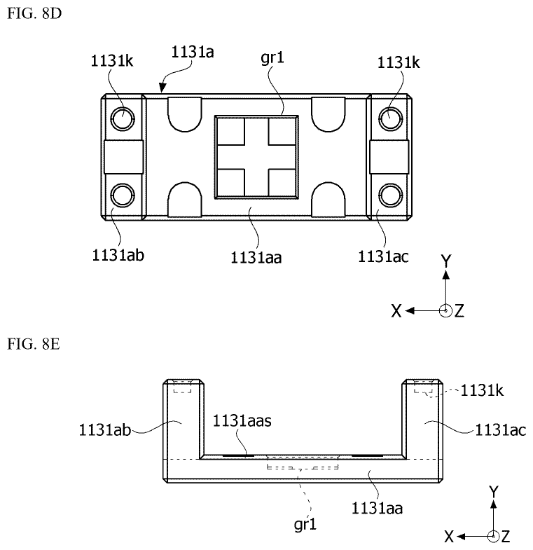

FIG. 8A is a perspective view of a holder of the first camera actuator according to the embodiment, FIG. 8B is a bottom view of a holder of the first camera actuator according to the embodiment, FIG. 8C is a front view of the holder of the first camera actuator according to the embodiment, FIG. 8D is a rear view of a second member of the first camera actuator according to the embodiment, and FIG. 8E is a bottom view of the second member of the first camera actuator according to the embodiment.

Referring to FIGS. 8A to 8E, the holder 1131 may include a seating surface 11310 on which the optical member 1132 is seated. The seating surface 11310 may be an inclined surface. In addition, the holder 1131 may include a stepped portion above the seating surface 11310. In addition, the stepped portion of the holder 1131 may be coupled to the protrusion (not illustrated) of the optical member 1132.

The holder 1131 may include a plurality of outer surfaces. For example, the holder 1131 may include a first holder outer surface 1131S1, a second holder outer surface 1131S2, a third holder outer surface 1131S3, and a fourth holder outer surface 1131S4.

The first holder outer surface 1131S1 and the second holder outer surface 1131S2 may be located to face each other. That is, the first holder outer surface 1131S1 may be disposed symmetrically with the second holder outer surface 1131S2 with respect to the first direction (the X-axis direction).

The first holder outer surface 1131S1 may be located to correspond to the first housing side portion. That is, the first holder outer surface 1131S1 may be located to face the first housing side portion. In addition, the second holder outer surface 1131S2 may be located to correspond to the second housing side portion. That is, the second holder outer surface 1131S2 may be located to face the second housing side portion.

In addition, the first holder outer surface 1131S1 may include a first seating groove 1131S1a. In addition, the second holder outer surface 1131S2 may include a second seating groove 1131S2a. The first seating groove 1131S1a and the second seating groove 1131S2a may be symmetrically disposed with respect to the first direction (the X-axis direction).

In addition, the first seating groove 1131S1a and the second seating groove 1131S2a may be disposed to overlap each other in the second direction (the Y-axis direction). In addition, the first magnet may be disposed in the first seating groove 1131S1a, and the second magnet may be disposed in the second seating groove 1131S2a. The first magnet and the second magnet may also be symmetrically disposed with respect to the first direction (the X-axis direction). In the specification, it should be understood that the first magnet to the third magnet may be coupled to the housing through a yoke or a bonding member. A pole of the first magnet and a pole of the second magnet may be opposite to each other. For example, an N pole and an S pole of the first magnet may be sequentially arranged in the third direction, and an S pole and an N pole of the second magnet may be sequentially arranged in the third direction. As a modified example, the pole of the first magnet and the pole of the second magnet may be the same as each other by adjusting the current injection or current directions of the first and second coils.

As described above, due to locations of the first and second seating grooves and the first and second magnets, an electromagnetic force generated by each magnet may be coaxially provided to the first holder outer surface S1131S1 and the second holder outer surface 1131S2. For example, a region (e.g., a portion having the strongest electromagnetic force) of the first holder outer surface S1131S1 to which the electromagnetic force is applied and a region (e.g., a portion having the strongest electromagnetic force) of the second holder outer surface S1131S1 to which the electromagnetic force is applied may be located on an axis parallel to the second direction (the Y-axis direction). Accordingly, the X-axis tilting may be accurately performed.

A first magnet 1151a may be disposed in the first seating groove 1131S1a, and a second magnet 1151b may be disposed in the second seating groove 1131S2a.

The third holder outer surface 1131S3 may be an outer surface that is in contact with the first holder outer surface 1131S1 and the second holder outer surface 1131S2 and extends from one sides of the first holder outer surface 1131S1 and the second holder outer surface 1131S2 in the second direction (the Y-axis direction). In addition, the third holder outer surface 1131S3 may be located between the first holder outer surface 1131S1 and the second holder outer surface 1131S2. The third holder outer surface 1131S3 may be the lower surface of the holder 1131. That is, the third holder outer surface 1131S3 may be located to face the third housing side portion.

In addition, the third holder outer surface 1131S3 may include a third seating groove 1131S3a. The third magnet may be located at the third seating groove 1131S3a. The third holder outer surface 1131S3 may be located to face the third housing side portion 1123.

In addition, at least a portion of the third housing hole 1123a may overlap the third seating groove 1131S3a in the first direction (the X-axis direction). Accordingly, the third magnet in the third seating groove 1131S3a and the third coil in the third housing hole 1123a may be located to face each other. In addition, the third magnet and the third coil may generate an electromagnetic force so that the second camera actuator may tilt with respect to the Y axis.

In addition, the X-axis tilting may be performed by a plurality of magnets (first and second magnets), while the Y-axis tilting may be performed by only the third magnet.

In an embodiment, the third seating groove 1131S3a may have a larger area than the first seating groove 1131S1a or the second seating groove 1131S2a. With this configuration, the Y-axis tilting may be performed by current control similar to the X-axis tilting.

The fourth holder outer surface 1131S4 may be an outer surface that is in contact with the first holder outer surface 1131S1 and the second holder outer surface 1131S2 and extends from the first holder outer surface 1131S1 and the second holder outer surface 1131S2 in the first direction (the X-axis direction). In addition, the fourth holder outer surface 1131S4 may be located between the first holder outer surface 1131S1 and the second holder outer surface 1131S2. That is, the fourth holder outer surface 1131S4 may be located to face the first member.

The fourth holder outer surface 1131S4 may include a fourth seating groove 1131S4a. The tilting guide part 1141 may be located at the fourth seating groove 1131S4a. In addition, the second member 1131a and the first member 1126 may be located at the fourth seating groove 1131S4a. In addition, the fourth seating groove 1131S4a may include a plurality of regions. The fourth seating groove 1131S4a may include a first region AR1, a second region AR2, and a third region AR3.

The second member 1131a may be located in the first region AR1. That is, the first region AR1 may overlap the second member 1131a in the first direction (the X-axis direction). In particular, the first region AR1 may be a region in which the member base portion of the second member 1131a is located. In this case, the first region AR1 may be located at the fourth holder outer surface 1131S4. That is, the first region AR1 may correspond to a region located above the fourth seating groove 1131S4a. In this case, the first region AR1 may not be one region in the fourth seating groove 1131S4a.

The first member 1126 may be located in the second region AR2. That is, the second region AR2 may overlap the first member 1126 in the first direction (the X-axis direction).

In addition, the second region AR2 may be located at the fourth holder outer surface 1131S4 like the first region. That is, the second region AR2 may correspond to a region located above the fourth seating groove 1131S4a.

The tilting guide part may be located in the third region AR3. In particular, the base of the tilting guide part may be located in the third region AR3. That is, the third region AR3 may overlap the tilting guide part (e.g., the base) in the first direction (the X-axis direction).

In addition, the second region AR2 may be located between the first region AR1 and the third region AR3.

In addition, the second member may be disposed in the first region AR1, and the second member 1131a may include the first groove gr1. In an embodiment, the second member 1131a may include the first groove gr1 formed in an inner surface 1131aas. In addition, the second magnetic body may be disposed in the first groove gr1 as described above.

In addition, as described above, the first member may be disposed in the second region AR2. The first groove gr1 may be located to face the second groove gr2. For example, at least a portion of the first groove grT may overlap the second groove gr2 in the third direction (the Z-axis direction).

In addition, the repulsive force generated by the second magnetic body may be transmitted to the fourth seating groove 1131S4a of the holder 1131 through the second member. Accordingly, the holder may apply a force to the tilting guide part in the same direction as the repulsive force generated by the second magnetic body.

The first member may include the second groove gr2 facing the first groove grT formed in the outer surface thereof. In addition, the first member may include the second protrusion groove formed in the inner surface thereof as described above. In addition, the second protrusion may be seated in the second protrusion groove.

In addition, like the second magnetic body, the repulsive force generated by the first magnetic body and the second magnetic body may be applied to the first member. Accordingly, the first member and the second member may press the tilting guide part disposed between the first member and the holder 1131 through the repulsive force.

The tilting guide part 1141 may be disposed in the third region AR3.

In addition, a first protrusion groove PH1 may be located at the fourth seating groove 1131S4a. In addition, the first protrusion of the tilting guide part 1141 may be accommodated in the first protrusion groove PH1. Accordingly, the first protrusion PR1 may be in contact with the first protrusion groove. A maximum diameter of the first protrusion groove PH1 may correspond to a maximum diameter of the first protrusion PR1. This may also be applied to the second protrusion groove and a second protrusion PR2 in the same manner. That is, a maximum diameter of the second protrusion groove may correspond to a maximum diameter of the second protrusion PR2. Accordingly, the second protrusion may be in contact with the second protrusion groove. With this configuration, first-axis tilting and second-axis tilting can be easily performed with respect to the first protrusion and the second protrusion, respectively, and a tilting radius can be increased.

In addition, in an embodiment, the first protrusion groove PH1 may be provided as a plurality of first protrusion grooves. For example, one of the first protrusion groove PH1 and the second protrusion groove PH2 may include a 1-1 protrusion groove PH1a and a 1-2 protrusion groove PH1b. Hereinafter, an example in which the first protrusion groove PH1 includes the 1-1 protrusion groove PH1a and the 1-2 protrusion groove PH1b will be described. In addition, the following description may also be applied to the second protrusion groove PH2 in the same manner. For example, the second protrusion groove PH2 may include a 2-1 protrusion groove and a 2-2 protrusion groove, in which the description of the 1-1 protrusion groove may be applied to the 2-1 protrusion groove, and the description of the 1-2 protrusion groove may be applied to the 2-2 protrusion groove.

The 1-1 protrusion groove PH1a and the 1-2 protrusion groove PH1b may be disposed side by side in the first direction (the X-axis direction). The 1-1 protrusion groove PH1a and the 1-2 protrusion groove PH1b may have the same maximum area or different maximum areas.

A plurality of first protrusion grooves PH1 may have the different number of inclined surfaces. For example, the first protrusion groove PH1 may include a groove lower surface and an inclined surface. In this case, the plurality of protrusion grooves may have the different number of inclined surfaces. In addition, areas of lower surfaces of the protrusion grooves may also be different.

For example, the 1-1 protrusion groove PH1a may include a first groove lower surface LS1 and a first inclined surface CS1. The 1-2 protrusion groove PH1b may include a second groove lower surface LS2 and a second inclined surface CS2.

In this case, areas of the first groove lower surface LS1 and the second groove lower surface LS2 may be different. The area of the first groove lower surface LS1 may be smaller than the area of the second groove lower surface LS2.

In addition, the number of first inclined surfaces CS1 in contact with the first groove lower surface LS1 may differ from the number of second inclined surfaces CS2. For example, the number of first inclined surfaces CS1 may be more than the number of second inclined surfaces CS2.

With this configuration, it is possible to easily compensate for an assembly tolerance of the first protrusion seated in the first protrusion groove PH1. For example, since the number of first inclined surfaces CS1 is more than the number of second inclined surfaces CS2, the first protrusion may be in contact with more inclined surfaces, thereby more accurately holding the location of the first protrusion in the 1-1 protrusion groove PH1a.

Unlike this, since the 1-2 protrusion groove PH1b has a smaller number of inclined surfaces in contact with the first protrusion than the 1-1 protrusion groove PH1a, the location of the first protrusion can be easily adjusted.

In an embodiment, the second inclined surfaces CS2 may be disposed to be spaced apart from each other in the second direction (the Y-axis direction). In addition, the second groove lower surface LS2 may extend in the first direction (the X-axis direction) so that the first protrusion can easily move in the first direction (the X-axis direction) while being in contact with the second inclined surface CS2. That is, the location of the first protrusion in the 1-2 protrusion groove PH1b can be easily adjusted. In addition, the first protrusion groove PH1 may be coated with a lubricating member.

In addition, in the present embodiment, heights of the first region AR1, the second region AR2, and the third region AR3 may be different in the first direction (the X-axis direction). In an embodiment, the height of the first region AR1 may be greater than those of the second region AR2 and the third region AR3 in the first direction (the X-axis direction). Accordingly, a stepped portion may be located between the first region AR1 and the second region AR2.

In addition, the second member 1131a may include the first groove gr1. That is, the first groove gr1 may be located at an inner surface of a member base portion 1131aa. In addition, the above second magnetic body may be seated in the first groove gr1. In addition, the first groove gr1 may be provided as a plurality of first grooves according to the number of second magnetic bodies. That is, the number of first grooves gr1 may correspond to the number of second magnetic bodies.

In addition, the second member 1131a may include the member base portion 1131aa, a first extension 1131ab, and a second extension 1131ac.

The member base portion 1131aa may be located at the outermost side of the first camera actuator. The member base portion 1131aa may be located outside the first member. That is, the first member may be located between the member base portion 1131aa and the tilting guide part.

The first extension 1131ab may extend from an edge of the member base portion 1131aa in the third direction (the Z-axis direction). That is, the first extension 1131ab may extend from the member base portion 1131aa to the holder 1131. This is also applied to the second extension 1131ac in the same manner. In addition, the second extension 1131ac may extend from the edge of the member base portion 1131aa in the third direction (the Z-axis direction). In an embodiment, the first extension 1131ab and the second extension 1131ac may be located at the edge of the member base portion 1131aa in the second direction (the Y-axis direction). In addition, the first extension 1131ab and the second extension 1131ac may be disposed between an upper member and a lower member.

Accordingly, the second member 1131a may have a groove formed by the first extension 1131ab and the second extension 1131ac. That is, the groove may be located between the first extension 1131ab and the second extension 1131ac. Accordingly, the first extension 1131ab and the second extension 1131ac may be connected by only the member base portion 1131aa. With this configuration, the second member 1131a may continuously receive the repulsive force generated by the second magnetic body seated at a central portion of the member base portion 1131aa, particularly, in the first groove gr1.

In addition, the first extension 1131ab may be spaced apart from the second extension 1131ac in the second direction (the Y-axis direction) to form a separation space. The first member and the tilting guide part may be seated in such a separation space. In addition, the second magnetic body and the first magnetic body may be located at the separation space.

In addition, the first extension 1131ab and the second extension 1131ac may have the same length in the third direction (the Z-axis direction). Accordingly, a coupling force, a weight, etc. can be formed in a balanced manner so that the tilting of the holder can be accurately performed without being biased to one side.

In addition, the first extension 1131ab and the second extension 1131ac may be coupled to the holder. In the present specification, it should be understood that coupling may be made through the bonding member other than the above protrusion and groove structures. In an embodiment, the first extension 1131ab and the second extension 1131ac may include a third coupling groove 1131k formed in the third direction (the Z-axis direction). In addition, a coupling protrusion 1131m may be located in a region in which the first extension 1131ab and the second extension 1131ac overlap each other in the third direction (the Z-axis direction) in the fourth seating groove 1131S4a. The coupling protrusion 1131m may be located to correspond to the third coupling groove 1131k.

For example, the third coupling groove 1131k may be coated with the bonding member, such as an epoxy or the like. In addition, the coupling protrusion 1131m may be inserted into the third coupling groove 1131k of the first extension 1131ab and the second extension 1131ac. With this configuration, the second member 1131a and the holder 1131 may be coupled. In addition, the repulsive force applied to the second member 1131a may be transmitted to the holder 1131 through such coupling.

However, it should be understood that the locations of the protrusion and groove structures may be interchanged as described above.

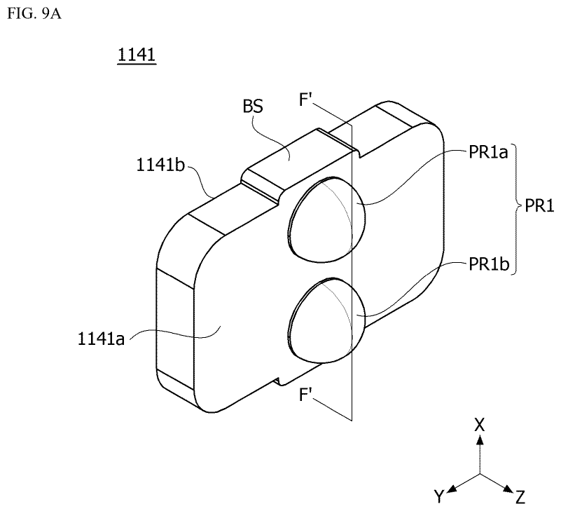

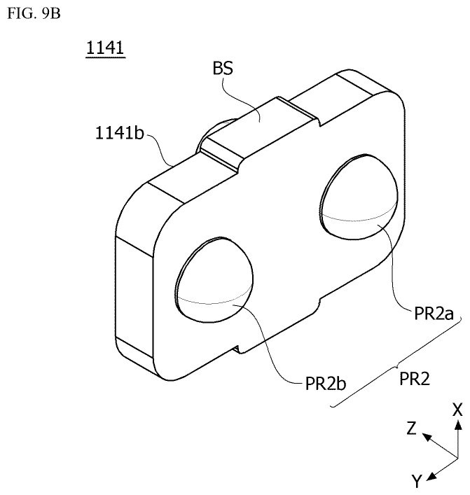

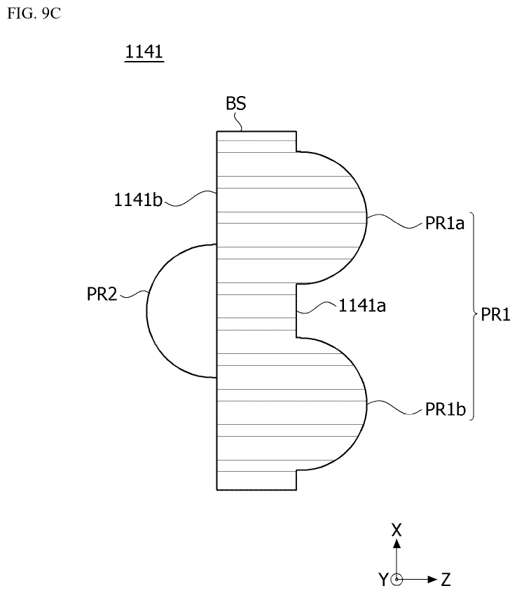

FIG. 9A is a perspective view of a tilting guide part of the first camera actuator according to the embodiment, FIG. 9B is a perspective view in a different direction from FIG. 9A, and FIG. 9C is a cross-sectional view along line FF′ in FIG. 9A.

Referring to FIGS. 9A to 9C, the tilting guide part 1141 according to the embodiment may include a base BS, the first protrusion PR1 protruding from a first surface 1141a of the base BS, and the second protrusion PR2 protruding from a second surface 1141b of the base BS. In addition, the first protrusion and the second protrusion may be formed on opposite surfaces according to a structure, but will be described below based on the drawings. In addition, it should be understood that the first protrusion PR1 and the second protrusion PR2 may be integrally formed with the base BS, and as shown in the drawings, the first protrusion PR1 and the second protrusion PR2 may have a spherical shape like a ball. That is, the tilting guide part 1141 may have a configuration including a ball member, a rolling member, a ball, a separated hemisphere, etc. In the case of an integrated type, it is possible to suppress foreign substances from flowing into the tilting guide part 1141, thereby improving reliability.

First, the base BS may include the first surface 1141a and the second surface 1141b facing the first surface 1141a. That is, the first surface 1141a may be spaced apart from the second surface 1141b in the third direction (the Z-axis direction), and the first surface 1141a and the second surface 1141b may be outer surfaces opposite to or facing each other in the tilting guide part 1141.

The tilting guide part 1141 may include the first protrusion PR1 extending to one side on the first surface 1141a. According to the embodiment, the first protrusion PR1 may protrude from the first surface 1141a to the holder. The first protrusion PR1 may be provided as a plurality of first protrusions and may include a 1-1 protrusion PR1a and a 1-2 protrusion PR1b.

The 1-1 protrusion PRla and the 1-2 protrusion PR1b may be located side by side in the first direction (the X-axis direction). That is, the 1-1 protrusion PR1a and the 1-2 protrusion PR1b may overlap each other in the first direction (the X-axis direction). In addition, in an embodiment, the 1-1 protrusion PRla and the 1-2 protrusion PR1b may be bisected by a virtual line extending in the first direction (the X-axis direction).

In addition, the 1-1 protrusion PRla and the 1-2 protrusion PR1b may have a curvature and have, for example, a hemispherical shape. In addition, the 1-1 protrusion PRla and the 1-2 protrusion PR1b may be in contact with the first groove of the housing at a point which is the farthest from the first surface 1141a of the base BS.

In addition, an align groove 1141aa may be located at the first surface 1141a. The align groove 1141aa may be disposed at one side of the first surface 1141a to provide an assembly location or an assembly direction of the tilting guide part 1141 during an assembly process.

In addition, the tilting guide part 1141 may include the second protrusion PR2 extending to one side on the second surface 1141b. According to the embodiment, the second protrusion PR2 may protrude from the second surface 1141b toward the housing. In addition, the second protrusion PR2 may be provided as a plurality of second protrusions and may include a 2-1 protrusion PR2a and a 2-2 protrusion PR2b in the embodiment.

The 2-1 protrusion PR2a and the 2-2 protrusion PR2b may be located side by side in the second direction (the Y-axis direction). That is, the 2-1 protrusion PR2a and the 2-2 protrusion PR2b may overlap each other in the second direction (the Y-axis direction). In addition, in an embodiment, the 2-1 protrusion PR2a and the 2-2 protrusion PR2b may be bisected by a virtual line extending in the second direction (the Y-axis direction).

The 2-1 protrusion PR2a and the 2-2 protrusion PR2b may have a curvature and have, for example, a hemispherical shape. In addition, the 2-1 protrusion PR2a and the 2-2 protrusion PR2b may be in contact with the coupling member 1131a at a point that is spaced apart from the second surface 1141b of the base BS.

The 1-1 protrusion PRla and the 1-2 protrusion PR1b may be located in a region between the 2-1 protrusion PR2a and the 2-2 protrusion PR2b in the second direction. According to the embodiment, the 1-1 protrusion PRla and the 1-2 protrusion PR1b may be located at a central portion of a separation space between the 2-1 protrusion PR2a and the 2-2 protrusion PR2b in the second direction. With this configuration, the actuator according to the embodiment may have an angle of the X-axis tilting in the same range with respect to the X-axis. That is, the tilting guide part 1141 and the holder may equally provide a range (e.g., a positive/negative range) in which the X-axis tilting may be performed with respect to the 1-1 protrusion PRla and the 1-2 protrusion PR1b with respect to the X-axis.

In addition, the 2-1 protrusion PR2a and the 2-2 protrusion PR2b may be located in a region between the 1-1 protrusion PRla and the 1-2 protrusion PR1b in the first direction. According to the embodiment, the 2-1 protrusion PR2a and the 2-2 protrusion PR2b may be located at a central portion of a separation space between the 1-1 protrusion PRla and the 1-2 protrusion PR1b in the first direction. With this configuration, the actuator according to the embodiment may have an angle of the Y-axis tilting in the same range with respect to the Y-axis. That is, the tilting guide part 1141 and the holder may equally provide a range (e.g., a positive/negative range) in which the Y-axis tilting may be performed with respect to the 2-1 protrusion PR2a and the 2-2 protrusion PR2b with respect to the Y-axis.

The first protrusion PR1 may protrude from the base BS toward the mover 1130, and the second protrusion PR2 may protrude from the base BS toward the first member or in a direction opposite to the first protrusion PR1.

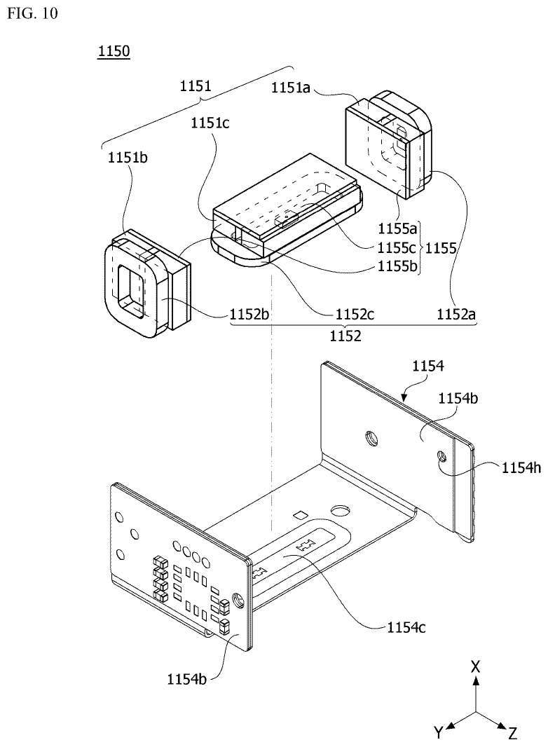

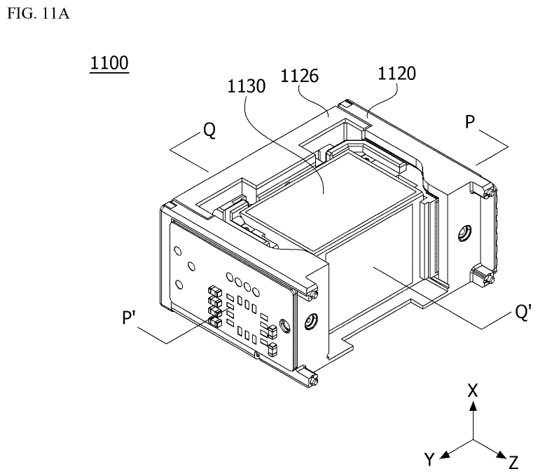

FIG. 10 is a view illustrating a first driving unit of the first camera actuator according to the embodiment.

Referring to FIG. 10, the driving unit 1150 includes the driving magnet 1151, the driving coil 1152, the Hall sensor part 1153, the substrate part 1154, and the yoke part 1155.

In addition, as described above, the driving magnet 1151 may include the first magnet 1151a, the second magnet 1151b, and the third magnet 1151c, which provide a driving force generated by an electromagnetic force. The first magnet 1151a, the second magnet 1151b, and the third magnet 1151c may each be located at the outer surface of the holder 1131.

In addition, the driving coil 1152 may include a plurality of coils. In an embodiment, the driving coil 1152 may include the first coil 1152a, the second coil 1152b, and the third coil 1152c.

The first coil 1152a may be located to face the first magnet 1151a. Accordingly, as described above, the first coil 1152a may be located at the housing hole 1121a of the first housing side portion 1121. In addition, the second coil 1152b may be located to face the second magnet 1151b. Accordingly, as described above, the second coil 1152b may be located at the second housing hole 1122a of the second housing side portion 1122.

The second camera actuator according to the embodiment may control the mover 1130 to rotate along the first axis (in the X-axis direction) or the second axis (in the Y-axis direction) by the electromagnetic force between the driving magnet 1151 and the driving coil 1152, thereby minimizing the occurrence of a decentering or tilting phenomenon and providing the best optical characteristics during implementation of an OIS.

In addition, according to the embodiment, it is possible to provide an ultra-slim and ultra-small camera actuator and the camera module including the same by implementing the OIS through the tilting guide part 1141 of the rotating part 1140 disposed between the housing 1120 and the mover 1130 to resolve the size limitations of the actuator.

The first substrate part 1154 may include a first substrate side portion 1154a, a second substrate side portion 1154b, and a third substrate side portion 1154c.

The first substrate side portion 1154a and the second substrate side portion 1154b may be disposed to face each other. In addition, the third substrate side portion 1154c may be located between the first substrate side portion 1154a and the second substrate side portion 1154b.

In addition, the first substrate side portion 1154a may be located between the first housing side portion and the shield can, and the second substrate side portion 1154b may be located between the second housing side portion and the shield can. In addition, the third substrate side portion 1154c may be located between the third housing side portion and the shield can and may be a lower surface of the first substrate part 1154.

The first substrate side portion 1154a may be coupled to and electrically connected to the first coil 1152a. In addition, the first substrate side portion 1154a may be coupled and electrically connected to the first Hall sensor 1153a.

The second substrate side portion 1154b may be coupled to and electrically connected to the second coil 1152b. In addition, it should be understood that the second substrate side portion 1154b may be coupled to and electrically connected to the first Hall sensor.

The third substrate side portion 1154c may be coupled to and electrically connected to the third coil 1152c. In addition, the third substrate side portion 1154c may be coupled and electrically connected to a second Hall sensor 1153b.

The yoke part 1155 may include a third yoke 1155a, a fourth yoke 1155b, and a fifth yoke 1155c. The third yoke 1155a may be located at the first seating groove and coupled to the first magnet 1151a. In addition, the fourth yoke 1155b may be located at the second seating groove and coupled to the second magnet 1151b. In addition, the fifth yoke 1155c may be located at the third seating groove and coupled to the third magnet 1151c. The third to fifth yokes 1155a to 1155c allow the first to the third magnets 1151a to 1151c to be easily seated in the first to third seating grooves and coupled to the housing.

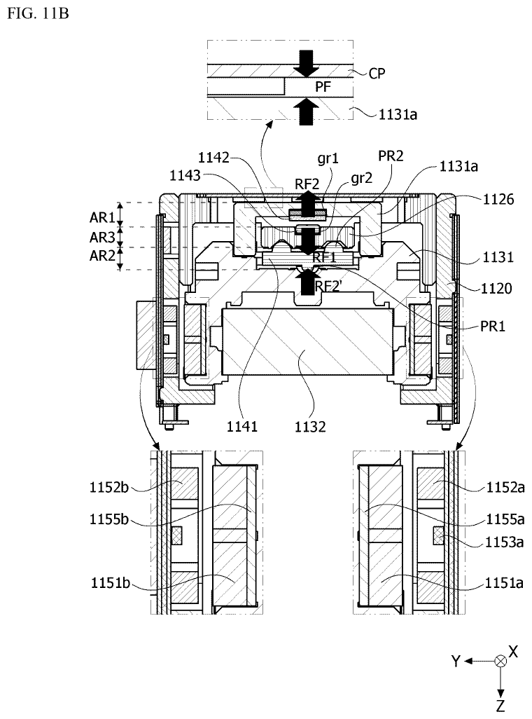

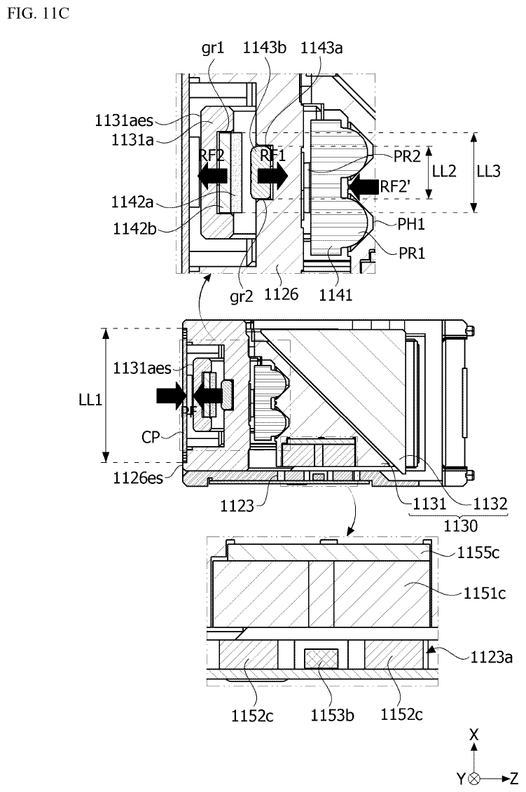

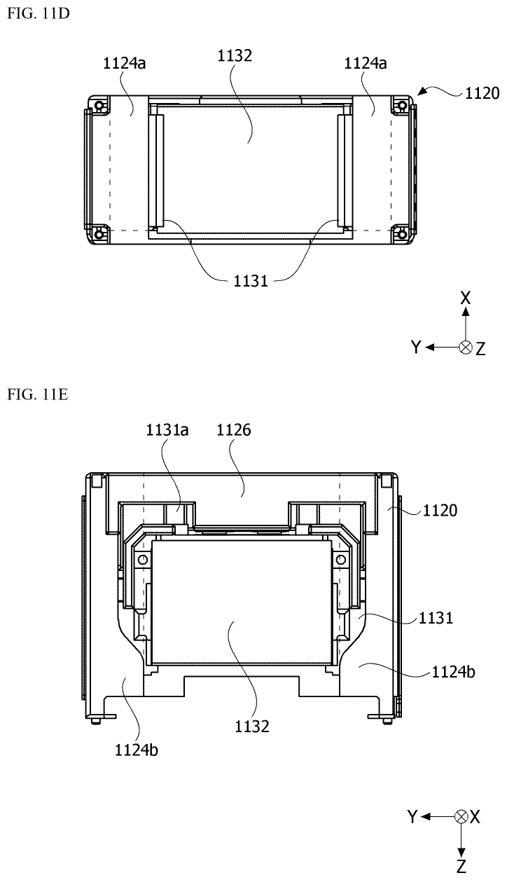

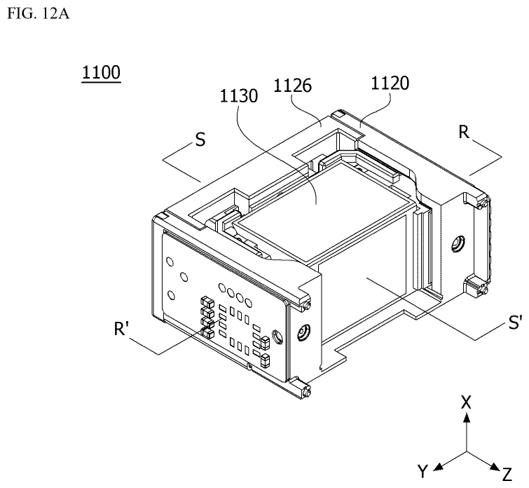

FIG. 11A is a perspective view of the first camera actuator according to the embodiment, FIG. 11B is a view along line PP′ in FIG. 11A, FIG. 11C is a view along line QQ′ in FIG. 11A, FIG. 11D is a rear view of the first camera actuator according to the embodiment, and FIG. 11E is a top view of the first camera actuator according to the embodiment.

Referring to FIGS. 11A to 11E, the first coil 1152a may be located at the first housing side portion, and the first magnet 1151a may be located at the first holder outer surface of the holder 1131. Accordingly, the first coil 1152a and the first magnet 1151a may be located to face each other. At least a portion of the first magnet 1151a may overlap the first coil 1152a in the second direction (the Y-axis direction).

In addition, the second coil 1152b may be located at the second housing side portion, and the second magnet 1151b may be located at the second holder outer surface of the holder 1131. Accordingly, the second coil 1152b and the second magnet 1151b may be located to face each other. At least a portion of the second magnet 1151b may overlap the second coil 1152b in the second direction (the Y-axis direction).

In addition, the first coil 1151a and the second coil 1152b may overlap each other in the second direction (the Y-axis direction), and the first magnet 1151a and the second magnet 1151b may overlap each other in the second direction (the Y-axis direction).

With this configuration, an electromagnetic force applied to the outer surfaces of the holder (the first holder outer surface and the second holder outer surface) may be located on parallel axes in the second direction (the Y-axis direction) so that the X-axis tilting may be performed accurately and precisely.

In addition, the second protrusion PR2 of the tilting guide part 1141 may be in contact with the first member 1126 of the housing 1120. The second protrusion PR2 may be seated in the second protrusion groove formed in one side surface of the first member 1126. In addition, when the X-axis tilting is performed, the second protrusion PR2 may be a reference axis (or a rotational axis) of the tilting. Accordingly, the tilting guide part 1141 and the mover 1130 may move in the second direction.

In addition, as described above, the first Hall sensor 1153a may be located outside to be electrically connected and coupled to the first substrate part 1154. However, the embodiments of the present invention are not limited to such a location.

In addition, the third coil 1152c may be located at the third housing side portion, and the third magnet 1151c may be located at the third holder outer surface of the holder 1131. At least parts of the third coil 1152c and the third magnet 1151c may overlap in the first direction (the X-axis direction). Accordingly, a strength of the electromagnetic force between the third coil 1152c and the third magnet 1151c may be easily controlled.

As described above, the tilting guide part 1141 may be located at the fourth holder outer surface of the holder 1131. In addition, the tilting guide part 1141 may be seated in the fourth seating groove of the fourth holder outer surface. As described above, the fourth seating groove may include the first region AR1, the second region AR2, and the third region AR3.

The second member 1131a may be disposed in the first region AR1, and the second member 1131a may include the first groove gr1 formed in the inner surface of the second member 1131a. In addition, the second magnetic body 1142 may be disposed in the first groove gr1 as described above, and a repulsive force RF2 generated by the second magnetic body 1142 may be transmitted to the fourth seating groove of the holder 1131 through the second member 1131a (RF2′). Accordingly, the holder 1131 may apply a force to the tilting guide part 1141 in the same direction as the repulsive force RF2 generated by the second magnetic body 1142.

The first member 1126 may be disposed in the second region AR2. The first member 1126 may include the second groove gr2 facing the first groove gr1. In addition, the first member 1126 may include the second protrusion groove disposed in the surface corresponding to the second groove gr2. In addition, a repulsive force RF1 generated by the first magnetic body 1143 may be applied to the first member 1126. Accordingly, the first member 1126 and the second member 1131a may press the tilting guide part 1141 disposed between the first member 1126 and the holder 1131 through the generated repulsive forces RF1 and RF2′. Accordingly, even after the holder tilts with respect to the X-axis or the Y-axis by a current applied to the first and second coils or the third coil 1152c, the coupling (or the locations) between the holder 1131, the housing 1120, and the tilting guide part 1141 may be maintained.

The tilting guide part 1141 may be disposed in the third region AR3. As described above, the tilting guide part 1141 may include the first protrusion PR1 and the second protrusion PR2. In this case, the first protrusion PR1 and the second protrusion PR2 may be respectively disposed on the second surface and the first surface of the base. In this way, even in other embodiments, which will be described below, the first protrusion PR1 and the second protrusion PR2 may be located at various locations on surfaces facing the base.

The first protrusion groove PH1 may be located at the fourth seating groove. In addition, the first protrusion PR1 of the tilting guide part 1141 may be accommodated in the first protrusion groove. Accordingly, the first protrusion PR1 may be in contact with the first protrusion groove. The maximum diameter of the first protrusion groove may correspond to the maximum diameter of the first protrusion PR1. This may also be applied to the second protrusion groove and a second protrusion PR2 in the same manner. With this configuration, the first-axis tilting and the second-axis tilting can be easily performed with respect to the first protrusion PR1 and the second protrusion PR2, respectively, and a tilting radius can be increased.

In addition, the tilting guide part 1141 may be disposed side by side with the second member 1131a and the first member 1126 in the third direction (the Z-axis direction) so that the tilting guide part 1141 may overlap the optical member 1132 in the first direction (the X-axis direction). More specifically, in the embodiment, the first protrusion PR1 may overlap the optical member 1132 in the first direction (the X-axis direction). Furthermore, at least a portion of the first protrusion PR1 may overlap the third coil 1152c or the third magnet 1151c in the first direction (the X-axis direction). That is, in the camera actuator according to the embodiment, each protrusion, which is the central axis of the tilting, may be located adjacent to the center of gravity of the mover 1130. Accordingly, the tilting guide part may be located adjacent to the center of gravity of the holder. Accordingly, the camera actuator according to the embodiment can minimize a moment value at which the holder tilts and also minimize the consumption of the current applied to the coil part or the like to tilt the holder, thereby minimizing power consumption and improving the reliability of the device.

In addition, the second magnetic body 1142 and the first magnetic body 1143 may not overlap the third coil 1151c or the optical member 1132 in the first direction (the X-axis direction). That is, in the embodiment, the second magnetic body 1142 and the first magnetic body 1143 may be disposed to be spaced apart from the third coil 1151c or the optical member 1132 in the third direction (the Z-axis direction). Accordingly, it is possible to minimize the magnetic force transmitted from the second magnetic body 1142 and the first magnetic body 1143 to the third coil 1151c. Accordingly, according to the camera actuator according to the embodiment, it is possible to easily perform vertical driving (the Y-axis tilting) and minimize power consumption.

Furthermore, as described above, the second Hall sensor 1153b located inside the third coil 1152c may detect a change in magnetic flux and thus perform location sensing between the third magnet 1151c and the second Hall sensor 1153b. In this case, an offset voltage of the second Hall sensor 1153b may vary according to the influence of the magnetic field generated by the second magnetic body 1142 and the first magnetic body 1143.

The first camera actuator according to the embodiment may include the second member 1131a, the second magnetic body 1142, the first magnetic body 1143, the first member 1126, and the tilting guide part 1141, and the holder 1131 in the third direction, which may be sequentially disposed based on the outermost surface thereof. However, since the second magnetic body is located at the second member and the first magnetic body is located at the first member, the second member, the first member, the tilting guide part, and the holder may be sequentially disposed.

In addition, in an embodiment, separation distances of the second magnetic body 1142 and the first magnetic body 1143 from the holder 1131 (or the optical member 1132) in the third direction may be greater than separation distances between the tilting guide parts 1141. Accordingly, the second Hall sensor 1153b under the holder 1131 may also be disposed to be spaced a predetermined distance from the second magnetic body 1142 and the first magnetic body 1143.

Accordingly, it is possible to minimize the influence of the magnetic field generated by the second magnetic body 1142 and the first magnetic body 1143 on the second Hall sensor 1153b, thereby preventing the Hall voltage from being saturated by being concentrated to a positive or negative value. That is, such a configuration may allow a Hall electrode to have a range in which Hall calibration may be performed. Furthermore, a temperature also affects the electrode of the Hall sensor, and resolution power of a camera lens varies according to the temperature, but in the embodiment, it is possible to prevent the case in which the Hall voltage is concentrated to the positive or negative value to compensate for the resolution power of the lens correspondingly, thereby easily preventing the degradation of the resolution power.

In addition, a circuit for compensating for the offset with respect to the output (i.e., the Hall voltage) of the second Hall sensor 1153b can also be easily designed.

In addition, according to the embodiment, a portion of the tilting guide part 1141 may be located outward more than the fourth holder outer surface of the holder 1131.

The tilting guide part 1141 excluding the first protrusion PR1 and the second protrusion PR2 may be seated in the fourth seating groove with respect to the base. That is, a length of the base in the third direction (the Z-axis direction) may be smaller than a length of the fourth seating groove in the third direction (the Z-axis direction). With this configuration, it is possible to easily achieve miniaturization.

In addition, a maximum length of the tilting guide part 1141 in the third direction (the Z-axis direction) may be greater than a length of the fourth seating groove in the third direction (the Z-axis direction). Accordingly, as described above, an end of the second protrusion PR2 may be located between the fourth holder outer surface and the first member 1126. That is, at least a portion of the second protrusion PR2 may be located in a direction opposite to the third direction (the Z-axis direction) more than the holder 1131. That is, the holder 1131 may be spaced a predetermined distance from the end (the portion being in contact with the second protrusion groove) of the second protrusion PR2 in the third direction (the Z-axis direction).

In addition, a front surface 1131aes of the second member 1131a according to the embodiment may be spaced apart from a front surface 1126es of the first member 1126. In particular, the front surface 1131aes of the second member 1131a according to the embodiment may be located from the front surface 1126es of the first member 1126 in the third direction (the Z-axis direction). Alternatively, the front surface 1131aes of the second member 1131a according to the embodiment may be located inside the front surface 1126es of the first member 1126. To this end, the first member 1126 may have an inward extending and bent structure. In addition, a portion of the second member 1131a may be located at a groove formed by the extending and bent structure of the first member 1126.

With this configuration, since the second member 1131a is located inside the first member 1126, it is possible to increase space efficiency and achieve miniaturization. Furthermore, even when the driving (tilting or rotation of the mover 1130) by the electromagnetic force is performed, the second member 1131a does not protrude outward from the first member 1126 and thus can be blocked from being in contact with peripheral devices. Accordingly, it is possible to improve reliability.

In addition, a predetermined separation space may exist between the second magnetic body 1142 and the first magnetic body 1143. That is, the second magnetic body 1142 and the first magnetic body 1143 may face each other with the same pole.

In the first camera actuator according to the embodiment, the first magnetic body may be located at the housing 1120, and the second magnetic body may be located at the mover 1130.

As described above, according to the embodiment, the first magnetic body and the second magnetic body may be located facing each other to generate a repulsive force. The repulsive force is a holding force, and the location between the housing 1120 and the mover 1130 may be maintained by such a repulsive force.

More specifically, the first member 1126 may include the second groove gr2 disposed in the outer surface thereof. The first magnetic body 1143 may be located at the second groove gr2. In addition, the second groove gr2 may be located at a side (or a surface) opposite to the second protrusion groove in the first member 1126.

In addition, the second member 1131a may include the first groove gr1 facing the second groove gr2. The first groove gr1 may be located at the inner surface of the second member 1131a. In addition, the second magnetic body 1142 may be located at the first groove gr1.

In addition, the first member 1126 may be disposed at one side of the housing 1120. In addition, the second member 1131a may pass through the first member 1126 and may be coupled in contact with the holder 1131. Accordingly, the tilting guide part 1141 may be disposed between the first member 1126 and the mover 131 (or the holder).

In addition, the second magnetic body 1142, the first magnetic body 1143, and the tilting guide part 1141 may be disposed sequentially in the optical axis direction (the Z-axis direction). Furthermore, the second magnetic body 1142, the first magnetic body 1143, and the tilting guide part 1141 may overlap each other in the optical axis direction (the Z-axis direction).

Furthermore, the plate CP may be located at the outer surface of the first member 1126. Accordingly, the plate CP, the second magnetic body 1142, and the first magnetic body 1143 may be disposed sequentially in the optical axis direction.

In addition, the plate CP may have a length LL1 in the first direction (the X-axis direction), which is greater than a length LL2 of the second magnetic body 1142 in the first direction (the X-axis direction). In addition, the length LL2 of the second magnetic body 1142 in the first direction (the X-axis direction) may differ from a length LL3 of the first magnetic body 1143 in the first direction (the X-axis direction). For example, the length LL2 of the second magnetic body 1142 in the first direction (the X-axis direction) may be greater than the length LL3 of the first magnetic body 1143 in the first direction (the X-axis direction). In addition, an area XY of the plate CP may be greater than an area (an XY plane) of the first member 1126 or an area (an XY plane) of the second member 1131a. Furthermore, the plate CP may be a non-magnet as described above. Accordingly, the plate CP can suppress foreign substances from flowing into the first member 1126, the second member 1131a, the first magnetic body 1143, the second magnetic body 1142, etc. that are disposed inside the housing 1120.

In addition, the plate CP may be formed of a magnetic body. In this case, the plate CP may generate a magnetic force with the second magnetic body 1142. For example, an attractive force may be generated between the plate CP and the second magnetic body 1142. For example, the plate CP may generate an attractive force with the second magnetic body 1142 as a yoke. Accordingly, the attractive force generated between the plate CP and the second magnetic body 1142 may reinforce the above repulsive force. Accordingly, it is possible to further increase the holding force between the mover and the housing. In addition, it is possible to improve the reliability of the first camera actuator with the increased holding force. For example, the second magnetic body 1142 has a surface (or a region) 1142a that faces the first magnetic body 1143 and has the same pole as one surface 1143b of the first magnetic body 1143. In addition, the second magnetic body 1142 may have a surface 1142b that faces the plate CP and has a different pole from the plate CP. In this case, the plate CP may be formed of a magnetic body. Furthermore, the second magnetic body 1142 may have the one surface 1143b and the other surface 1143a that have different poles. Such description will be given based on a case in which the first magnetic body 1143 and the second magnetic body 1142 are magnets.

With this configuration, the repulsive force between the second magnetic body 1142 and the first magnetic body 1143 can be further increased by the plate CP. That is, an attractive force PF may be generated between the second magnetic body 1142 and the plate CP. Furthermore, the plate CP may be formed of a magnetic body, such as a metal, and may block leakage of a magnetic flux. For example, the plate CP can prevent leakage of the magnetic flux caused by the first magnetic body 1143 or the second magnetic body 1142. Accordingly, the plate CP can improve the electrical reliability of the first camera actuator.

In addition, the wall 1124a of the housing wall portion 1124 may not overlap with the optical member 1132 in the optical axis direction. In addition, the wall 1124a of the housing wall portion 1124 may be misaligned with the optical member 1132 in the optical axis direction.

In addition, the housing wall portion 1124 may overlap the holder in the optical axis direction (the Z-axis direction). Accordingly, for a hand-shake prevention function, even when the mover, that is, the holder tilts, a movement amount may be limited by the housing wall portion 1124. Furthermore, the housing wall portion 1124 and the holder may collide with each other so that no shock occurs in the first member or the second member. Accordingly, it is possible to improve the reliability of the first member and the second member.

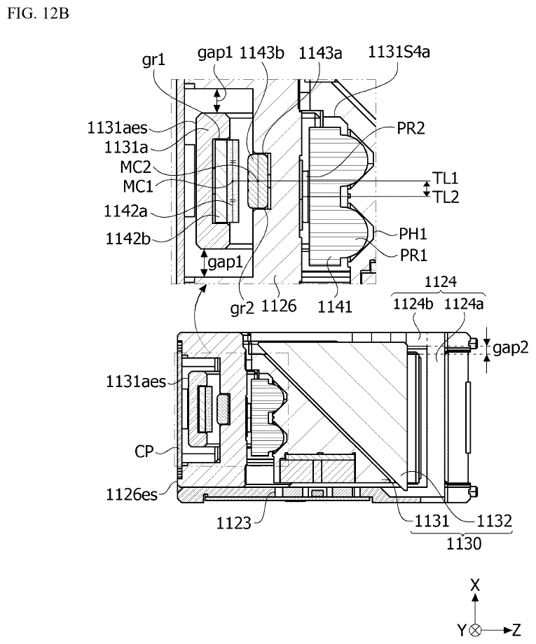

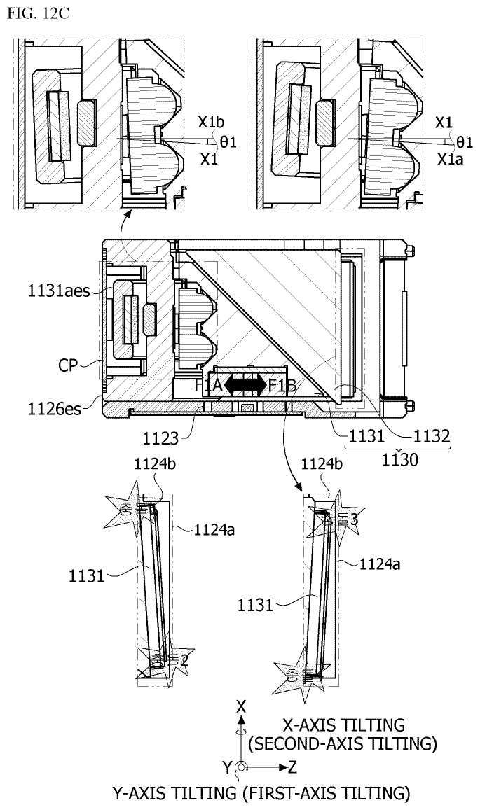

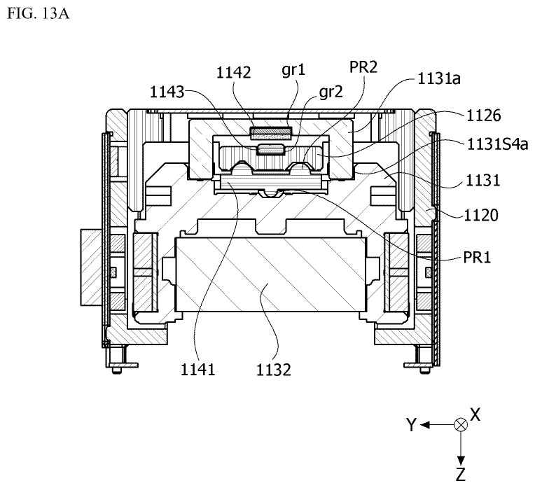

FIG. 12A is a perspective view of the first camera actuator according to the embodiment, FIG. 12B is a view along line SS' in FIG. 12A, and FIG. 12C is an exemplary view of movement of the first camera actuator illustrated in FIG. 12B.

Referring to FIGS. 12A to 12C, the Y-axis tilting may be performed by the first camera actuator according to the embodiment. That is, an OIS may be implemented by rotating the first camera actuator in the first direction (the X-axis direction).

In an embodiment, the third magnet 1151c disposed under the holder 1131 may generate the electromagnetic force with the third coil 1152c to tilt or rotate the mover 1130 with respect to the second direction (the Y-axis direction).

Specifically, the repulsive force between the second magnetic body 1142 and the first magnetic body 1143 may be transmitted to the second member 1131a and the first member 1126 and ultimately transmitted to the tilting guide part 1141 disposed between the first member 1126 and the holder 1131. Accordingly, the tilting guide part 1141 may be pressed by the mover 1130 and the housing 1120 due to the above repulsive force.

In addition, the second protrusion PR2 may be supported by the first member 1126. In this case, in an embodiment, the tilting guide part 1141 may rotate or tilt using the second protrusion PR2 protruding toward the first member 1126 as a reference axis (or a rotational axis), that is, with respect to the second direction (the Y-axis direction). That is, the tilting guide part 1141 may rotate or tilt using the second protrusion PR2 protruding toward the first member 1126 in the first direction (the X-axis direction) as the reference axis (or the rotational axis).

For example, an OIS can be implemented by rotating (X1→X1a) the mover 130 at a first angle θ1 in the X-axis direction by first electromagnetic forces F1A and F1B between the third magnet 1151c disposed in the third seating groove and the third coil 1152c disposed on the third substrate side portion.

Conversely, an OIS can be implemented by rotating (X1→X1b) the mover 130 at a first angle θ1 in a direction opposite to the X-axis direction by the first electromagnetic forces F1A and F1B between the third magnet 1151c disposed in the third seating groove and the third coil 1152c disposed on the third substrate side portion.

The first angle θ1 may range from +1° to +3°. However, the embodiments of the present invention are not limited thereto.

Hereinafter, in the first camera actuators according to various embodiments, the electromagnetic force may move the mover by generating a force in the described direction or move the mover in the described direction even when a force is generated in another direction. That is, the described direction of the electromagnetic force is a direction of the force generated by the magnet and the coil to move the mover. For example, the first electromagnetic forces F1A and F1B may act in a third direction or in a direction opposite to the third direction.

In addition, a center MC1 of the second magnetic body 1142 and a center MC2 of the first magnetic body 1143 may be disposed side by side in the third direction (the Z-axis direction). That is, a center line TL1 connecting the center MC1 of the second magnetic body 1142 to the center MC2 of the first magnetic body 1143 may be parallel to the third direction (the Z-axis direction).

In addition, a bisector TL2 that bisects the second protrusion PR2 and corresponds to the third direction (the Z-axis direction) may be parallel to the center line TL1 (or the bisector). That is, the bisector TL2 may be a line that bisects the second protrusion PR2 in the first direction (the X-axis direction) and may be provided as a plurality of bisectors.

In an embodiment, the bisector TL2 may be disposed to be spaced apart from the center line TL1 in the first direction (the X-axis direction). The bisector TL2 may be located above the center line TL1. With this configuration, since a separation distance between the third coil 1152c and the third magnet 1151c may be increased, the holder may more accurately perform two axes tilting. Furthermore, when a current is not applied to the coil, the location of the holder can be maintained equally.

More specifically, since the center MC1 of the second magnetic body 1142 and the center MC2 of the first magnetic body 1143 are spaced apart from the bisector TL2 in the first direction (the X-axis direction), the force (e.g., the repulsive force) between the second magnetic body 1142 and the first magnetic body 1143 may act at a distance spaced apart from the bisector TL2 corresponding to the optical axis in the first direction (the X-axis direction). In addition, a momentum is generated in the mover 1130 by such a force. However, when the center MC1 of the second magnetic body 1142 and the center MC2 of the first magnetic body 1143 are located on the bisector TL2, there is a problem that, during calibration, the locations of the tilting guide part and the second magnetic body 1142 are not maintained after tilting. That is, in the camera actuator according to the embodiment, since the center MC1 of the second magnetic body 1142 and the center MC2 of the first magnetic body 1143 are not disposed on the bisector TL2, the locations of the tilting guide part and the second magnetic body 1142 may be maintained after tilting or rotating.

In another embodiment, the center MC1 of the second magnetic body 1142 and the center MC2 of the first magnetic body 1143 may be disposed to be spaced apart from each other in the first direction (the X-axis direction).

In addition, the center MC1 of the second magnetic body 1142 and the center MC2 of the first magnetic body 1143 may not be located on the bisector TL2. For example, the center MC1 of the second magnetic body 1142 and the center MC2 of the first magnetic body 1143 may be located above the bisector TL2.

Accordingly, since the separation distance between the third coil 1152c and the third magnet 1151c increases, the holder may more accurately perform two axes tilting. Furthermore, when a current is not applied to the coil, the location of the holder can be held equally.

In addition, the lengths of the second magnetic body 1142 and the first magnetic body 1143 may be different in the first direction (the X-axis direction).

In an embodiment, the area of the second magnetic body 1142 that is coupled to the second member 1131a and tilts along with the mover 1130 may be greater than the area of the first magnetic body 1143. For example, a length of the second magnetic body 1142 in the first direction (the X-axis direction) may be greater than a length of the first magnetic body 1143 in the first direction (the X-axis direction). In addition, a length of the second magnetic body 1142 in the second direction (the Y-axis direction) may be greater than a length of the first magnetic body 1143 in the second direction (the Y-axis direction). In addition, the first magnetic body 1143 may be located in a virtual straight line extending both ends of the second magnetic body 1142 in the third direction.

With this configuration, even when the magnetic body at one side (e.g., the second magnetic body) tilts during tilting or rotating, it is possible to easily prevent forces other than the vertical force from being generated by the tilting. That is, even when the second magnetic body vertically tilts along with the mover 1130, the second magnetic body may not receive a force (e.g., a repulsive force or an attractive force) against the tilting from the first magnetic body 1143. Accordingly, it is possible to increase driving efficiency.

In addition, according to the embodiment, a gap gap2 between the housing extension 1124b and the holder 1131 may be smaller than a gap gap1 between the first member 1126 and the second member 1131a (the first and second extensions). Alternatively, a gap between the first member and the second member may be greater than a gap between the holder and the housing extension. In this case, the gap gap2 between the housing extension 1124b and the holder 1131 may be a length in the first direction (the X-axis direction). In addition, the gap gap1 between the first member 1126 and the second member 1131a (the first and second extensions) may also be a length in the first direction (the X-axis direction).

In addition, when the housing wall portion (the wall or the housing extension) is in contact with the holder 1131, the housing (excluding the housing wall portion) may be spaced a predetermined distance from the holder 1131. That is, when the holder 1131 tilts, the holder 1131 may primarily collide with the housing wall portion. Accordingly, it is possible to improve the reliability of the housing 1120 and the holder 1131. Specifically, when the housing wall portion (the wall or the housing extension) is in contact with the holder 1131, the first member 1126 may be spaced a predetermined distance from the second member 1131a. Accordingly, it is possible to eliminate the shock applied to the first member 1126 and the second member 1131a.

Furthermore, a gap between the first member 1126 and the second member 1131a facing each other in a direction perpendicular to the optical axis direction may be greater than a gap between an upper surface of the holder 1131 and a lower surface of the housing extension 1124b.

In an embodiment, when the holder 1131 tilts, the holder 1131 may collide with the housing wall portion or the housing sequentially or simultaneously in a plurality of regions.

When the holder 1131 tilts, the holder 1131 may primarily collide with the wall (collision 2 and collision 3), and then secondarily collide with the housing extension or the third housing side portion (or the wall) (collision 1 and collision 4). Accordingly, the third housing side portion may be in contact with the housing wall portion. In addition, a length of the third housing side portion in the optical axis direction may be greater than a length of the optical member 1132 in the optical axis direction. With this configuration, shock between the holder and the housing due to tilting does not occur in the first member and the second member, and it is possible to increase shock absorption efficiency.

In addition, when the holder 1131 tilts, the holder 1131 may primarily collide with the housing extension or the third housing side portion (or the wall) (collision 1 and collision 4), and then secondarily collide with the wall (collision 2 and collision 3). Accordingly, the third housing side portion may be in contact with the housing wall portion. Likewise, a length of the third housing side portion in the optical axis direction may be greater than a length of the optical member 1132 in the optical axis direction. With this configuration, shock between the holder and the housing due to tilting does not occur in the first member and the second member, and it is possible to increase shock absorption efficiency.

In addition, when the holder 1131 tilts, the holder 1131 may simultaneously collide with the housing extension, the third housing side portion (or the wall), and the like in a plurality of regions (collision 1 and collision 2 may occur simultaneously, or collision 3 and collision 4 may occur simultaneously).

Furthermore, with the above configuration, as described above, even when the mover 1130 rotates (X1→X1a or X1b) along the X-axis at the first angle θ1 by the first electromagnetic forces F1A and F1B, the collision between the first member 1126 and the second member 1131a may not occur. That is, the collision between the holder 1131 and the housing wall portion 1124 may occur preferentially. Accordingly, it is possible to suppress the collision between the first member 1126 and the second member 1131a, thereby improving the reliability of the first member 1126 and the second member 1131a of which locations are held to implement an OIS. Accordingly, it is possible to improve the reliability of the first camera actuator.

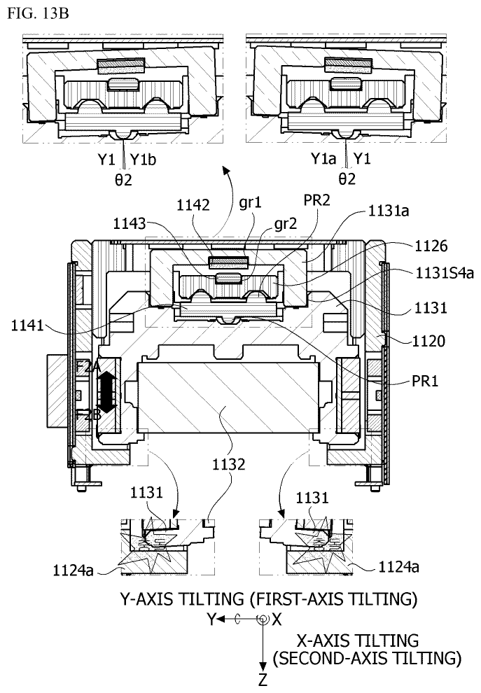

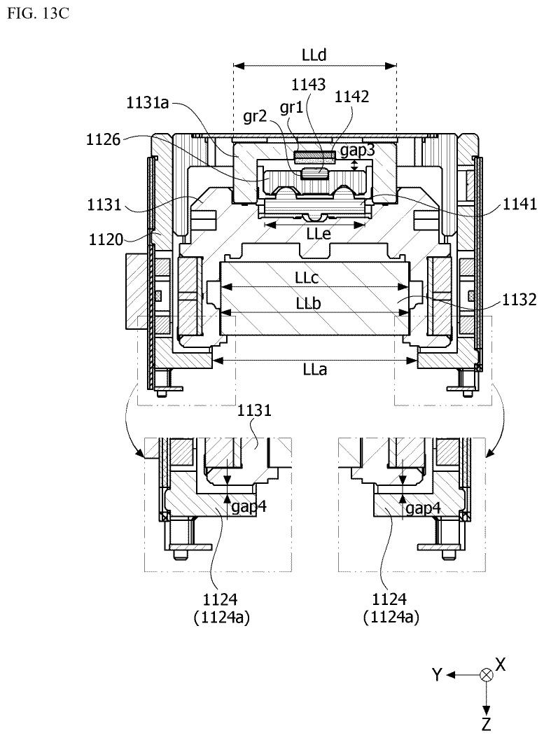

FIG. 13A is a view along line RR′ in FIG. 12A, FIG. 13B is an exemplary view of movement of the first camera actuator illustrated in FIG. 13A, and FIG. 13C is a view illustrating a collision of a housing wall portion with respect to the movement of the first camera actuator illustrated in FIG. 13A.

Referring to FIGS. 13A to 13C, X-axis tilting may be performed. That is, an OIS may be implemented by tilting or rotating the mover 1130 in the Y-axis direction.

In an embodiment, the first magnet 1151a and the second magnet 1151b disposed on the holder 1131 may generate the electromagnetic force with the first coil 1152a and the second coil 1152b, respectively, and tilt or rotate the tilting guide part 1141 and the mover 1130 with respect to the first direction (the X-axis direction).

Specifically, the repulsive force between the second magnetic body 1142 and the first magnetic body 1143 may be transmitted to the first member 1126 and the holder 1131 and ultimately transmitted to the tilting guide part 1141 disposed between the holder 1131 and the first member 1126. Accordingly, the tilting guide part 1141 may be pressed by the mover 1130 and the housing 1120 due to the above repulsive force.

In addition, the 1-1 protrusion PRla and the 1-2 protrusion PR1b may be spaced apart from each other in the first direction (the X-axis direction) and supported by the first protrusion groove PH1 formed in the fourth seating groove 1131S4a of the holder 1131. In addition, in an embodiment, the tilting guide part 1141 may rotate or tilt with respect to the first protrusion PR1 protruding toward the holder 1131 (e.g., in the third direction), which is the reference axis (or the rotational axis), that is, with respect to the first direction (the X-axis direction).

For example, an OIS can be implemented by rotating (Y1→Y1a or Y1b) the mover 130 at a second angle θ2 in the Y-axis direction by second electromagnetic forces F2A and F2B between the first and second magnets 1151a and 1151b disposed in the first seating groove and the first and second coils 1152a and 1152b disposed on the first and second substrate side portions. The second angle θ2 may range from ±1° to 3°. However, the embodiments of the present invention are not limited thereto.

In addition, as described above, the electromagnetic forces generated by the first and second magnets 1151a and 1151b and the first and second coils 1152a and 1152b may act in the third direction or in a direction opposite to the third direction. For example, the electromagnetic force may be generated on a left side portion of the mover 1130 in the third direction (the Z-axis direction) and may act on a right side portion of the mover 1130 in a direction opposite to the third direction (the Z-axis direction). Accordingly, the mover 1130 may rotate with respect to the first direction. Alternatively, the mover 130 may move in the second direction.

In this way, the second camera actuator according to the embodiment may control the mover 1130 to rotate in the first direction (the X-axis direction) or the second direction (the Y-axis direction) by the electromagnetic force between the driving magnet in the holder and the driving coil disposed in the housing, thereby minimizing the occurrence of a decentering or tilting phenomenon and providing the best optical characteristics during the implementation of the OIS. In addition, as described above, “Y-axis tilting” refers to rotation or tilting in the first direction (the X-axis direction), and “X-axis tilting” refers to rotation or tilting in the second direction (the Y-axis direction).

According to the embodiment, the wall 1124a of the housing wall portion 1124 may not overlap the optical member 1132 in the optical axis direction. That is, the wall 1124a of the housing wall portion 1124 may be misaligned with the optical member 1132 in the optical axis direction. In addition, a distance LLa between adjacent walls 1124a in the second direction may be greater than a length LLb of the seating surface of the holder 1131 in the second direction. In addition, the distance LLa between the adjacent walls 1124a in the second direction may be greater than a length LLc of the optical member 1132 in the second direction. Accordingly, it is possible to prevent the collision between the optical member 1132 and the wall 1124a, thereby preventing damage to the optical member 1132. Furthermore, the light emitted through the optical member 1132 cannot be blocked by the wall 1124a.

In a modified example, a portion of the housing wall portion 1124 may overlap the optical member 1132 in the optical axis direction. In this case, the housing wall portion 1124 and the optical member 1132 may not be in contact with each other. That is, even when the mover tilts, the housing wall portion 1124 and the optical member 1132 may not be in contact with each other. In addition, even when the mover maximally tilts, the housing wall portion 1124 and the optical member 1132 may be spaced apart from each other.

In addition, an optical member may be disposed between the first magnet and the second magnet. In addition, the housing wall portion 1124 or the wall 1124a may overlap the first magnet 1151a and the second magnet 1151b in the optical axis direction (the Z-axis direction). Accordingly, the shock caused by the first magnet 1151a and the second magnet 1151b that have relatively great weights can be easily absorbed by the wall 1124a.

In addition, the distance LLa between the adjacent walls 1124a in the second direction may be greater than the length LLd of the second member 1131a in the second direction. In addition, the distance LLa between the adjacent walls 1124a in the second direction may be greater than a length LLe of the tilting guide part 1141 in the second direction. Accordingly, the housing wall portion 1124 and the second member 1131a may not overlap each other in the optical axis direction (the Z-axis direction). The housing wall portion 1124 and the second member 1131a may be misaligned in the optical axis direction (the Z-axis direction).

With this configuration, an effective region of the optical member 1132 can be maximized. In addition, the holder 1131 may have a small rotation radius for driving of an OS, thereby miniaturizing the camera actuator.

In an embodiment, a distance between the first magnetic body 1143 and the second magnetic body 1142 may be greater than a distance between the holder 1131 and the housing wall portion 1124. In addition, even when the holder 1131 tilts, a distance between the first groove and the second groove may be greater than the distance between the holder 1131 and the housing wall portion 1124. Furthermore, even when the holder 1131 tilts and the housing wall portion and the holder 1131 are in contact with each other, the first groove and the second groove may be spaced apart from each other. For example, a gap gap3 between the first magnetic body 1143 and the second magnetic body 1142 may be greater than a gap gap4 between the holder 1131 and the wall 1124a. With this configuration, even when the holder 1131 is moved by movement or shock of the holder 1131, a collision between the holder 1131 and the housing wall portion 1124 may primarily occur. Accordingly, it is possible to suppress the occurrence of shock on the first member and the second member by which a holding force is generated for rotation. Accordingly, it is possible to improve the reliability of the first member and the second member, thereby improving the reliability of the first camera actuator.

In addition, when the housing wall portion (the wall or the housing extension) is in contact with the holder 1131, the housing (excluding the housing wall portion) may be spaced a predetermined distance from the holder 1131. That is, when the holder 1131 tilts, the holder 1131 may primarily collide with the housing wall portion. Accordingly, it is possible to improve the reliability of the housing 1120 and the holder 1131. Specifically, when the housing wall portion (the wall or the housing extension) is in contact with the holder 1131, the first member 1126 may be spaced a predetermined distance from the second member 1131a. Accordingly, it is possible to eliminate the shock applied to the first member 1126 and the second member 1131a.

In addition, the housing wall portion 1124 may not overlap the first magnetic body 1143 or the second magnetic body 1142 in the optical axis direction.

In addition, the housing wall portion 1124 may not overlap the first magnetic body 1143, the second magnetic body 1142, and the second member 1131a in the optical axis direction or the third direction (the Z-axis direction). Accordingly, it is possible to secure the size or effective diameter of the optical member.

Furthermore, the gap between the first member 1126 and the second member 1131a may correspond to the gap gap3 between the first magnetic body 1143 and the second magnetic body 1142. Accordingly, the gap between the first member 1126 and the second member 1131a may be greater than the gap gap4 between the holder 1131 and the housing wall portion 1124. With this configuration, even when the holder 1131 is moved by movement or shock of the holder 1131, a collision between the holder 1131 and the housing wall portion 1124 may primarily occur. Accordingly, it is possible to suppress the occurrence of shock on the first member and the second member by which a holding force is generated for rotation. In addition, it is also possible to suppress a collision between the first magnet and the second magnet. Accordingly, it is possible to suppress a change in the repulsive force generated by the first magnet and the second magnet. Accordingly, it is possible to improve the reliability of the first camera actuator.

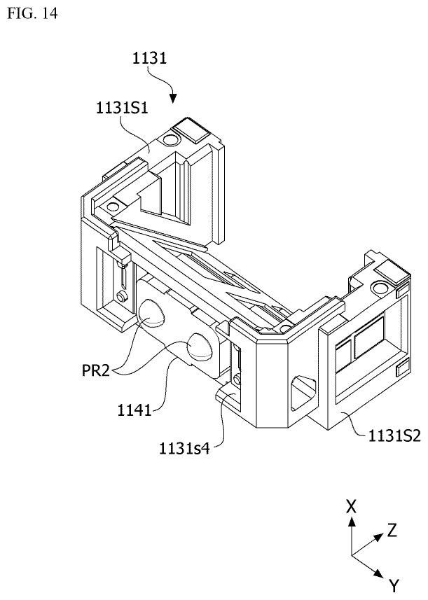

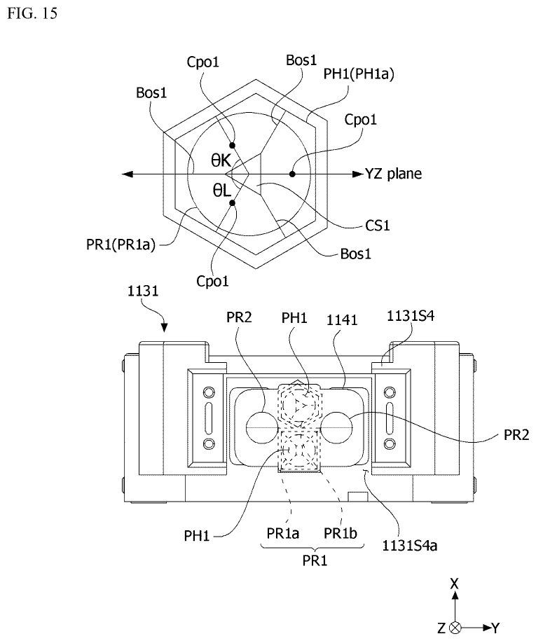

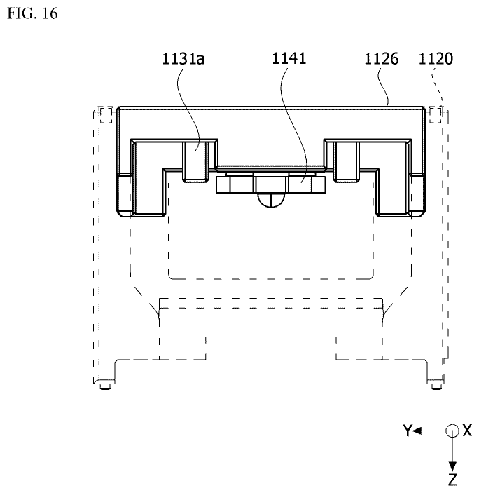

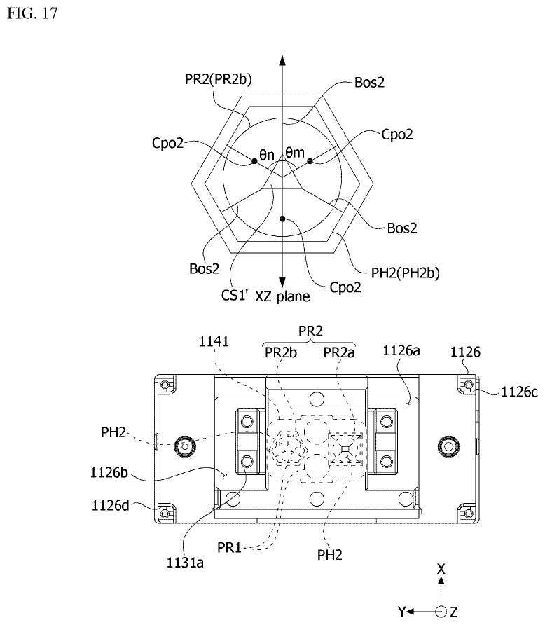

FIG. 14 is a perspective view illustrating the holder and the tilting guide part in the first camera actuator according to the embodiment, FIG. 15 is a side view illustrating the holder and the tilting guide part in the first camera actuator according to the embodiment, FIG. 16 is a top view of a housing, a first member, and the tilting guide part in the first camera actuator according to the embodiment, and FIG. 17 is a side view of the first member and the tilting guide part in the first camera actuator according to the embodiment.

Referring to FIGS. 14 to 17, in the first camera actuator according to the embodiment, as described above, the plurality of first protrusions PR1 of the tilting guide part 1141 may be disposed to be spaced apart from each other in the first direction (the X-axis direction). In addition, a plurality of second protrusions PR2 of the tilting guide part 1141 may be disposed to be spaced apart from each other in the second direction (the Y-axis direction). Accordingly, the mover may rotate about the first protrusion PR1. For example, the mover may rotate using the first direction as a center axis. In addition, the mover and the tilting guide part may rotate about the second protrusion PR2. For example, the mover and the tilting guide part may rotate using the second direction as a center axis.

In an embodiment, the holder 1131 or the mover may include a plurality of first protrusion grooves PH1 in which the plurality of first protrusions PR1 are disposed. As described above, the number of the plurality of first protrusions PR1 and the number of the plurality of first protrusion grooves PH1 may be the same.

Likewise, the housing or the first member 1126 may include the second protrusion groove PH2 in which the plurality of second protrusions PR2 are disposed. The number of the plurality of second protrusions PR2 and the number of the plurality of second protrusion grooves PH2 may be the same.

In an embodiment, at least one of the plurality of first protrusion grooves PH1 (or the plurality of second protrusion grooves) may have an odd number of inclined surfaces. The plurality of first protrusion grooves PH1 may have an odd number of inclined surfaces CS1. For example, the odd number of inclined surfaces CS1 is N, and N may be 3 or more.

In addition, a boundary surface between adjacent inclined surfaces among the odd number of inclined surfaces may be bisected by a plane perpendicular to the first direction (or the second direction). In addition, one of the odd number of inclined surfaces according to the embodiment may be bisected by the plane perpendicular to the first direction (or the second direction). Here, the bisected boundary surface and the bisected inclined surface may face each other.

Specifically, among the odd number of inclined surfaces CS1 of the first protrusion groove PH1, a first boundary surface BOS1 between adjacent inclined surfaces may be bisected by a plane (a YZ plane) or line perpendicular to the first direction. In the case of bisection, the line or plane between the bisected adjacent inclined surfaces may have an error of area or length within 10%.

In addition, one of the odd number of inclined surfaces CS1 may be bisected by the plane (the YZ plane) perpendicular to the first direction.

In addition, the first protrusion PR1 may be disposed on the first protrusion groove PH1. In this case, the first protrusion PR1 may be in contact with the inclined surface CST. For example, the first protrusion PR1 may be in contact with the inclined surface CS1 at a first contact point CPO1.

In addition, the plurality of first contact points CPO1 may correspond to the number of inclined surfaces CS1. Furthermore, a center (or a center of gravity) of the plurality of first contact points CPO1 may be located on the plane (the YZ plane) perpendicular to the first direction. Furthermore, angles θₖ and θ_{L} formed by the plurality of first contact points CPO1 on the bisected adjacent inclined surfaces and the center of the first contact points CPO1 with respect to the plane (the YZ plane) may be the same. For example, when the number of inclined surfaces CST is 3, the angles θₖ and θ_{L} may be 60 degrees. Due to a tolerance, the angles θₖ and θ_{L} may range from 55 degrees to 65 degrees.

Among an odd number of inclined surfaces CS1′ of the second protrusion groove PH2, a second boundary surface BOS2 between adjacent inclined surfaces may be bisected by a plane (an XZ plane) or line perpendicular to the second direction. In the case of bisection, the line or plane between the bisected adjacent inclined surfaces may have an error of area or length within 10%.

In addition, one of the odd number of inclined surfaces CS1′ may be bisected by the plane (the XZ plane) perpendicular to the seocond direction. In addition, the bisected boundary surface and the bisected inclined surface may face each other.

In addition, the second protrusion PR2 may be disposed on the second protrusion groove PH2. In this case, the second protrusion PR2 may be in contact with the inclined surface CS1′. For example, the second protrusion PR2 may be in contact with the inclined surface CS1′ at a second contact point CPO2.

In addition, the plurality of second contact points CPO2 may correspond to the number of inclined surfaces CS1′. Furthermore, a center (or a center of gravity) of the plurality of second contact points CPO2 may be located on the plane (the XZ plane) perpendicular to the second direction. Furthermore, angles θₘ and θₙ formed by the plurality of second contact points CPO2 on the bisected adjacent inclined surfaces and the center of the second contact points CPO2 with respect to the plane (the XZ plane) may be the same. For example, when the number of inclined surfaces CS1′ is 3, the angles θₘ and θₙ may be 60 degrees. Due to a tolerance, the angles θₘ and θₙ may range from 55 degrees to 65 degrees.

With this configuration, it is possible to suppress the phenomenon in which the contact point between the first and second protrusions of the tilting guide part changes due to a deviation of dimensions within the first and second protrusion grooves. That is, it is possible to improve the seating stability of the protrusions of the tilting guide part in the protrusion grooves of the first member and the mover. Accordingly, it is possible to improve the accuracy of the driving of the OIS of the first camera actuator.

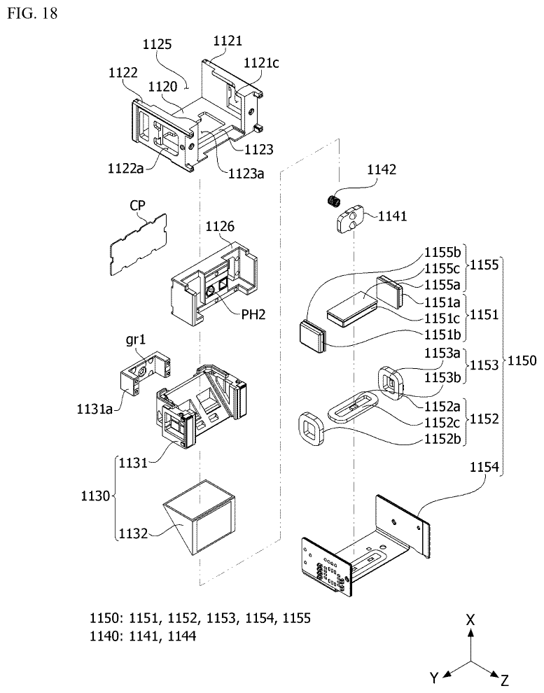

FIG. 18 is an exploded perspective view of a first camera actuator according to another embodiment.

Referring to FIG. 18, the first camera actuator according to another embodiment includes the housing 1120, the mover 1130, the rotating part 1140, the driving unit 1150, the sixth housing side part 1126, and the coupling member 1131a. The above contents excluding the following description may be applied in the same manner. In particular, the first camera actuator according to the embodiment may include an elastic member in addition to the first magnetic body and the second magnetic body.

The rotating part 1140 may include the tilting guide part 1141 and an elastic member 1144 to press the tilting guide part 1141. That is, the rotating part 1140 includes the tilting guide part 1141 and the elastic member 1144 that provides an elastic restoring force to press the tilting guide part 1141. The elastic member 1144 may press the tilting guide part 1141 to the mover 1130.

In addition, the elastic member 1144 may be seated in the first groove formed in the coupling member 1131a and the second groove formed in the sixth housing side portion 1126. That is, the first groove and the second groove may be located inside the coupling member 1131a or inside the sixth housing side portion 1126.

The elastic member 1144 may generate an elastic restoring force between the mover 1130 and the sixth housing side portion. The elastic restoring force may be applied to the coupling member 1131a or the holder 1131 coupled to one end of the elastic member 1144 and the sixth housing side portion 1126 or the housing 1120 coupled to the other end of the elastic member 1144. In this case, the elastic restoring force applied to the coupling member 1131a may be transmitted to the holder 1131 coupled to the coupling member 1131a. Accordingly, the tilting guide part 1141 disposed between the coupling member 1131a and the sixth housing side portion 1126 may be pressed by the elastic restoring force. That is, the elastic restoring force can maintain the tilting guide part 1141 located between the holder 1131 and the housing 1120 (or the sixth housing side portion 1126). With this configuration, the location between the mover 1130 and the housing 1120 may be maintained even during X-axis tilting or Y-axis tilting. In addition, the tilting guide part may be in close contact with the sixth housing side portion 1126 and the holder 1131 by the elastic restoring force.

In addition, as described above, the elastic member 1144 may be located at the first groove and the second groove.

At least a portion of the elastic member 1144 may be accommodated in the first groove and the second groove. In this case, the first groove and the second groove may be coated with a bonding member to be bonded to the elastic member 1144. Accordingly, it is possible to increase a coupling force between the elastic member 1144 and the first groove and the second groove. Alternatively, the first groove and the second groove may not be coated with the bonding member to be bonded to the elastic member 1144. Accordingly, problems, such as an overflow of the bonding member or the like, may not occur.

In addition, as described above, the elastic member 1144 may be disposed between the housing 1120 and the bonding member 1131a. In addition, the elastic member 1144 may cause the mover 1130 to press the tilting guide part 1141 through the elastic restoring force. In addition, the mover 1130 may be rotated in the first direction (the X-axis direction) and/or the second direction (the Y-axis direction).

For example, the elastic member 1144 may include a coil spring.

In an embodiment, the elastic member may provide an elastic restoring force of 100 mN to 140 mN. Preferably, the elastic member may provide an elastic restoring force of 120 mN. In response to the elastic restoring force, the elastic member may have a structure as shown in Table 1 below.

TABLE 1

| Name | Example 1 | Example 2 | Example 3 |
|---|---|---|---|
| Line diameter [Ψ] | 0.1 | 0.1 | 0.11 |
| Pitch [mm] | 0.2 | 0.25 | 0.2 |
| Outer diameter [Ψ] | 1.1 | 1.1 | 1.1 |
| Inner diameter [Ψ] | 0.9 | 0.9 | 0.9 |
| Force [mN] | 120 | 120 | 120 |
| Length [mm] | 2.5 | 2 | 1.7 |
| Simulation compression | 1.4123 | 0.9028 | 0.60808 |
| amount [mm] | | | |

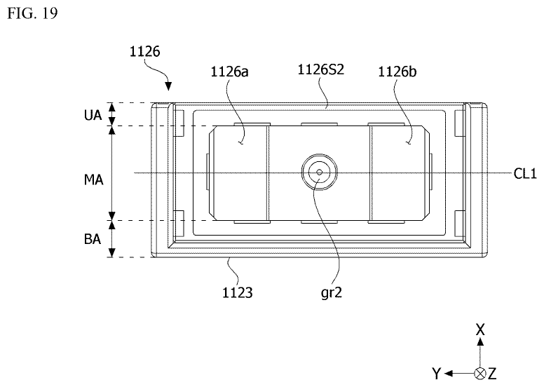

Referring to Table 1, to maintain the elastic restoring force, the elastic member may have a pitch that decreases in response to the elastic restoring force when the length increases. In addition, even when the length decreases, the line diameter may increase to maintain the elastic restoring force. In addition, the elastic member may have a length of 1.0 mm to 1.2 mm when compressed. In addition, the elastic member according to the embodiment may have a ratio between the lengths of the examples of Table 1. For example, the elastic member may have a line diameter of 0.1 to 0.11. In addition, the pitch of the elastic member may range from 0.2 to 0.25 mm. In addition, the elastic member may have a length of 1.7 to 2.5. However, the embodiments of the present invention are not limited to these limitations. FIG. 19 is a front view of a housing of the first camera actuator according to another embodiment.

Referring to FIG. 19, the housing side portion of the housing 1120 may include the second groove gr2. For example, the first member or the sixth housing side portion 1126 may include the second groove gr2. The second groove gr2 may be located to face the first groove. The second groove gr2 may be located at the outer surface 1126S2 of the sixth housing side portion 1126. The elastic member may be seated on the second groove gr2. In addition, the outer surface 1126S2 of the sixth housing side portion 1126 may face the inner surface of the coupling member or the member base portion. Furthermore, the elastic member may be seated on the first groove of the coupling member and the second groove of the sixth housing side portion 1126. The first and second grooves may face each other, and the elastic member between the first groove and the second groove may generate the above elastic restoring force. Accordingly, since the sixth housing side portion 1126 presses the tilting guide part inward or the holder by the elastic restoring force, the mover may be spaced a predetermined distance from the third housing side portion within the housing even when no current is applied to the coil. That is, the coupling force between the mover, the housing, and the tilting guide part can be maintained. In addition, in the present embodiment, the coupling force between the mover, the housing, and the tilting guide part can be maintained by the elastic restoring force.

In addition, as described above, the elastic member may be disposed in the first groove.

As described above, the sixth housing side portion may be disposed in the second region. The first groove may be located to face the second groove. For example, at least a portion of the first groove may overlap the second groove in the third direction (the Z-axis direction). Since the elastic member is disposed in the first groove and the second groove, the elastic member may be located in the first region and the second region.

In addition, the elastic restoring force of the elastic member may be transmitted to the fourth seating groove of the holder 1131 through the coupling member. Accordingly, the holder may apply a force to the tilting guide part in the same direction as the elastic restoring force generated by the elastic member.

In addition, the first groove may be provided as a plurality of first grooves according to the number of elastic members. That is, the number of first grooves may be formed to correspond to the number of elastic members.

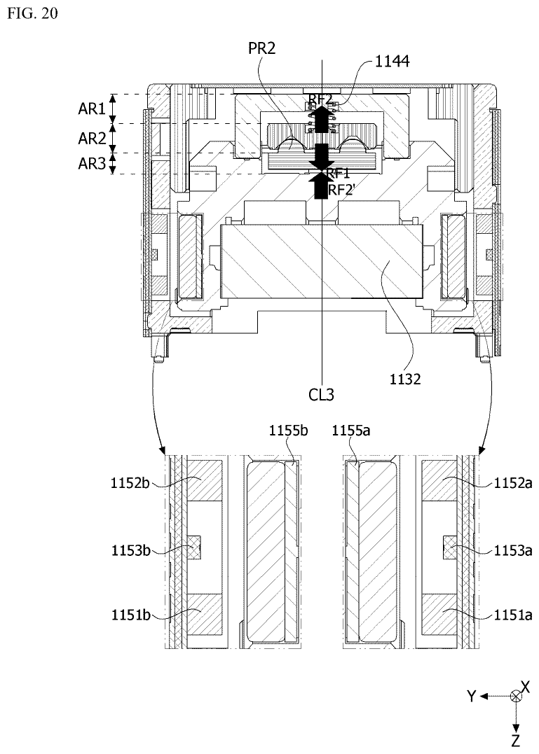

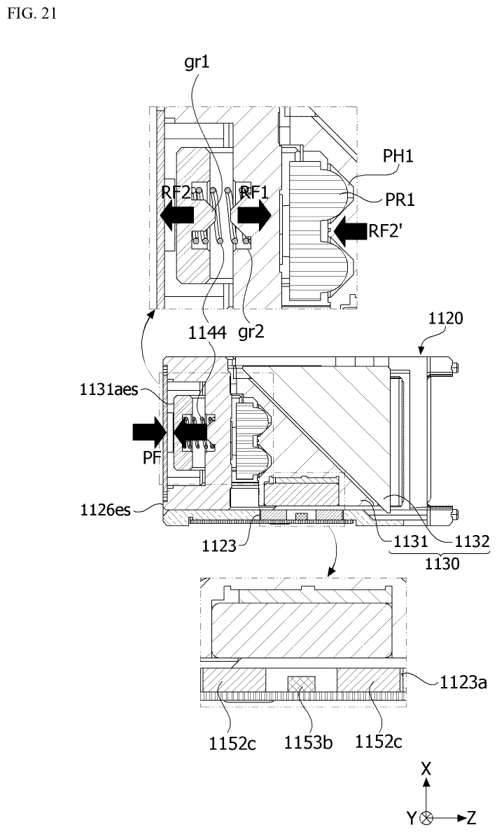

FIG. 20 is one cross-sectional view of the first camera actuator according to another embodiment, and FIG. 21 is another cross-sectional view of the first camera actuator according to another embodiment.

Referring to FIGS. 20 and 21, the coupling member 1131a may be disposed in the first region AR1, and the coupling member 1131a may include the first groove gr1 formed on an inner surface thereof. In addition, as described above, the elastic member 1144 may be disposed in the first groove gr1, and the elastic restoring force RF2 generated by the elastic member 1144 may be transmitted to the fourth seating groove 1131S4a of the holder 1131 through the coupling member 1131a (RF2′). Accordingly, the holder 1131 may apply a force to the tilting guide part 1141 in the same direction as the elastic restoring force RF2 generated by the elastic member 1144.

The sixth housing side portion 1126 may be disposed in the second region AR2. The sixth housing side portion 1126 may include the second groove gr2 facing the first groove gr1. In addition, the sixth housing side portion 1126 may include the second protrusion groove PH2 disposed in a surface corresponding the second groove gr2. In addition, the elastic restoring force RF1 generated by the elastic member 1144 may be applied to the sixth housing side portion 1126. Accordingly, the sixth housing side portion 1126 and the coupling member 1131a may press the tilting guide part 1141 disposed between the sixth housing side portion 1126 and the holder 1131 through the generated elastic restoring forces RFT and RF2′ (PF). Accordingly, even after the holder is tilted with respect to the X-axis or the Y-axis by a current applied to the first and second coils or the third coil 1152c, the coupling between the holder 1131, the housing 1120, and the tilting guide part 1141 can be maintained.

In addition, a portion of the elastic member 1144 may be disposed in the second region AR2. That is, the elastic member 1144 may be located at the second groove gr2 that passes through a portion of the sixth housing side portion 1126. Accordingly, at least a portion of the elastic member 1144 may at least overlap the coupling member 1131a and the sixth housing side portion 1126 in the second direction (the Y-axis direction).

In addition, the second groove gr2 may further include a groove protrusion. The location of the elastic member seated in the second groove gr2 can be maintained by the groove protrusion. That is, the elastic member may be disposed to surround the groove protrusion. In addition, the groove protrusion may be located in a central region of the second groove gr2. In addition, a portion of the groove protrusion may extend to the outside of the second groove gr2. With this configuration, the elastic restoring force can be applied to the mover more efficiently.

As described above, the mover 1130 may include the optical member 1132, the holder 1131 coupled to the optical member 1132, and the coupling member 1131a coupled to the holder 1131. Accordingly, the tilting guide part 1141 may be in close contact with the sixth housing side portion and the holder 1131 by the elastic restoring force of the elastic member 1144. In addition, the coupling member 1131a may press the sixth housing side portion and the tilting guide part 1141 in the third direction. In addition, the coupling member 1131a may press the housing in the direction opposite to the third direction.

In addition, the elastic member 1144 may not overlap the third coil 1152c or the optical member 1132 in the first direction (the X-axis direction). That is, in the embodiment, the elastic member 1144 may be disposed to be spaced apart from the third coil 1152c or the optical member 1132 in the third direction (the Z-axis direction). Accordingly, according to the camera actuator according to the embodiment, it is possible to easily perform vertical driving (the Y-axis tilting) and minimize power consumption.

Furthermore, as described above, the second Hall sensor 1153b located inside the third coil 1152c may detect a change in magnetic flux and thus perform location sensing between the third magnet 1151c and the second Hall sensor 1153b.

According to the embodiment, the first camera actuator may be disposed in the order of the coupling member 1131a, the elastic member 1144, the sixth housing side portion 1126, the tilting guide part 1141, and the holder 1131 in the third direction. However, since the elastic member is located within the coupling member and the sixth housing side portion, the coupling member, the elastic member, the sixth housing side portion, the tilting guide part, and the holder may be sequentially disposed.

In addition, according to the embodiment, a separation distance between the elastic member 1144 and the holder 1131 (or the optical member 1132) in the third direction may be greater than a separation distance between the tilting guide parts 1141. Accordingly, the second Hall sensor 1153b under the holder 1131 may also be disposed to be spaced a predetermined distance from the elastic member 1144. Accordingly, the second Hall sensor 1153b can minimize the influence of the magnetic field generated by the elastic member 1144, thereby preventing a Hall voltage from being concentrated positively or negatively and saturated. That is, such a configuration may allow a Hall electrode to have a range in which Hall calibration may be performed. Furthermore, a temperature also affects the electrode of the Hall sensor, and resolution power of a camera lens varies according to the temperature, but in the embodiment, it is possible to prevent the case in which the Hall voltage is concentrated to the positive or negative value to compensate for the resolution power of the lens correspondingly, thereby easily preventing the degradation of the resolution power.

In addition, the elastic member 1144 may be formed of at least one elastic member. In an embodiment, the elastic member 1144 may be a spring. For example, the elastic member 1144 may include a coil spring. In addition, the elastic member 1144 may be disposed between the first through-hole and the second through-hole.

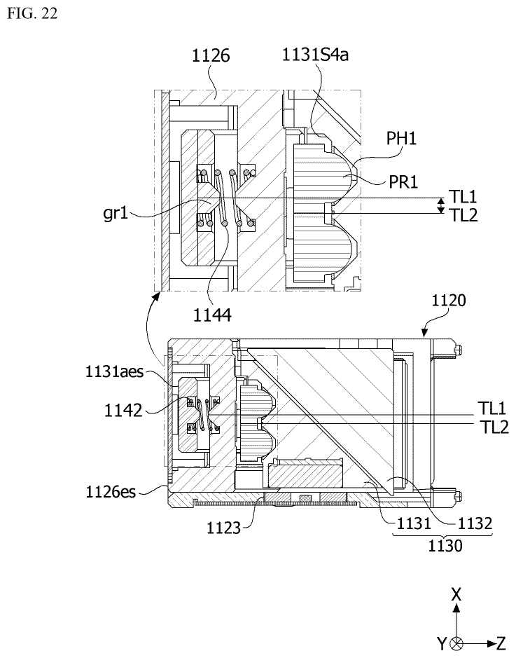

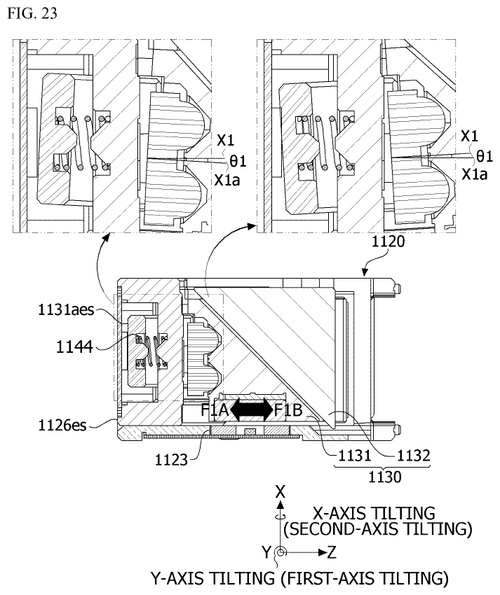

FIG. 22 is still another cross-sectional view of the first camera actuator according to another embodiment, and FIG. 23 is an exemplary view of movement of the first camera actuator illustrated in FIG. 22.

Referring to FIGS. 22 and 23, the elastic restoring force of the elastic member 1144 may be transmitted to the coupling member 1131a and the sixth housing side portion 1126 and ultimately to the tilting guide part 1141 disposed between the sixth housing side portion 1126 and the holder 1131. Accordingly, the tilting guide part 1141 has a holding force. In addition, the bisector TL2 that bisects the second protrusion PR2 and corresponds to the third direction (the Z-axis direction) may be parallel to the center line TL1 of the elastic member 1144. That is, the bisector TL2 may be a line that bisects the second protrusion PR2 in the first direction (the X-axis direction) and may be provided as a plurality of bisectors.

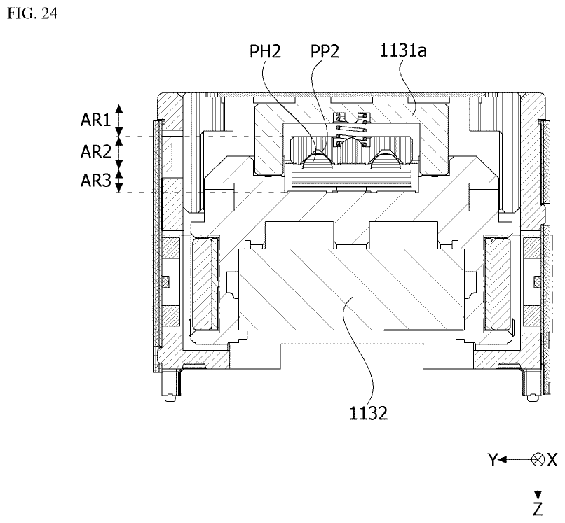

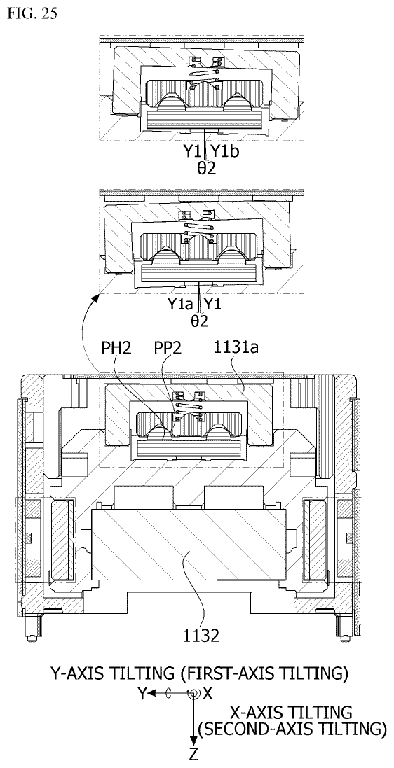

FIG. 24 is yet another cross-sectional view of the first camera actuator according to another embodiment, and FIG. 25 is an exemplary view of movement of the first camera actuator illustrated in FIG. 24.

Referring to FIGS. 24 and 25, the first magnet and the second magnet disposed on the holder 1131 may generate an electromagnetic force with the first coil and the second coil, respectively, to tilt or rotate the tilting guide part 1141 and the mover 1130 with respect to the first direction (the X-axis direction).

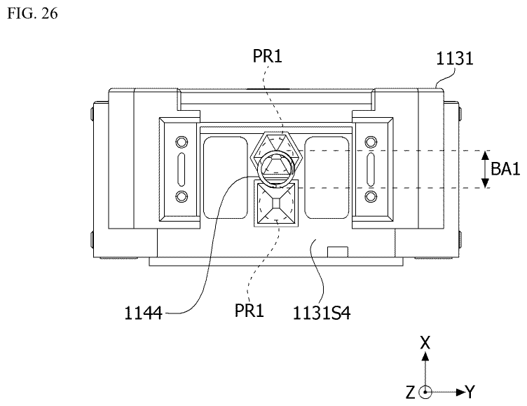

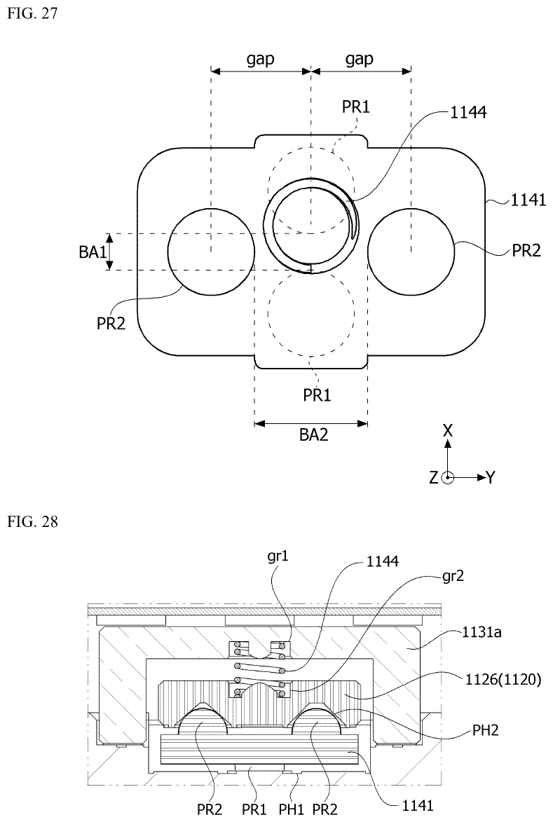

FIG. 26 is a side view of the holder and an elastic member in the first camera actuator according to the embodiment, FIG. 27 is a side view of the tilting guide part and the elastic member in the first camera actuator according to the embodiment, and FIG. 28 is a partially enlarged view of FIG. 24.

Referring to FIGS. 26 to 28, in the first camera actuator according to the embodiment, the elastic member 1144 may be disposed in a region between the plurality of first protrusions PR1 or a region between the plurality of second protrusions PR2 to press the tilting guide part 1141 to the mover (or holder). As described above, the elastic member 1144 may generate a holding force for the location of the holder 1131 within the housing 1120.

More specifically, the elastic member 1144 may be disposed in a region BAT between the plurality of first protrusions PR1. In addition, the elastic member 1144 may be disposed in a region BA2 between the plurality of second protrusions PR2.

In addition, the plurality of second protrusions PR2 may be located between the plurality of first protrusions PR1 and the elastic member 1144. For example, the second protrusion PR2 may be located in a region between the first protrusion PR1 and the elastic member 1144 in the optical axis direction or the third direction (the Z-axis direction).

In addition, the elastic member 1144 may be located in a separation region or the region BAT between the plurality of first protrusions PR1 in the first direction (the X-axis direction).

In addition, the line (or the plane) bisecting the elastic member 1144 in the second direction (the Y-axis direction) and the line (or the plane) bisecting the plurality of first protrusions PR1 in the second direction (the Y-axis direction) may be the same. With this configuration, the holder 1131 may accurately rotate about the first direction (the X-axis direction) based on the first protrusion PR1.

As a modified example, the line (or the plane) bisecting the elastic member 1144 in the second direction (the Y-axis direction) may be located within a plane perpendicular to the second direction or a line parallel to the second direction at the outermost edges (both ends) of the plurality of first protrusions PR1.

With this configuration, the holder 1131 can rotate more evenly using the first direction (the X-axis direction) as a reference axis.

In addition, at least a portion of the elastic member 1144 may not overlap the plurality of first protrusions PR1 in the optical axis direction. That is, at least a portion of the elastic member 1144 may be misaligned with the plurality of first protrusions PR1 in the optical axis direction or the third direction (the Z-axis direction).

For example, the elastic member 1144 may be disposed to be misaligned with the plurality of first protrusions PR1 in the optical axis direction. In addition, a portion of the elastic member 1144 may not overlap the plurality of first protrusions PR1 in the optical axis direction.

The location of the elastic member 1144 in the first direction (the X-axis direction) may move according to the center of gravity regarding the holder 1131. In addition, it is possible to increase the driving efficiency of the driving unit according to the center of gravity of the mover due to the movement of the elastic member 1144 in the first direction (the X-axis direction).

In an embodiment, the elastic member 1144 may have a region overlapping one of the plurality of first protrusions (or the plurality of first protrusion grooves) in the optical axis direction larger than a region overlapping another one in the optical axis direction. That is, the elastic member 1144 may be located above the middle between the plurality of first protrusions.

Accordingly, a portion of the elastic member 1144 may overlap the first protrusion in the optical axis direction. In addition, a portion of the elastic member 1144 may overlap the first protrusion groove in the optical axis direction.

In addition, the elastic member 1144 may be located in a separation region or the region BA2 between the plurality of second protrusions PR2 in the second direction (the Y-axis direction).

In addition, the line (or the plane) bisecting the elastic member 1144 in the second direction (the Y-axis direction) may be located within a plane perpendicular to the first direction or a line parallel to the first direction at the outermost edges (both ends) of the plurality of second protrusions PR2.

For example, separation distances gap between the plurality of second protrusions PR2 and the elastic member 1144 in the second direction may be the same. With this configuration, it is possible to improve the weight balance for the rotation of the mover and increase driving efficiency.

At least parts of the plurality of second protrusions PR2 may not overlap the elastic member 1144 in the second direction (the Y-axis direction). That is, the plurality of second protrusions PR2 may be disposed to be misaligned with the elastic member 1144 in the second direction.

Correspondingly, the second groove gr2 may partially overlap the elastic member 1144 in the second direction (the Y-axis direction), but may not overlap the second protrusion PR2 in the second direction (the Y-axis direction). Accordingly, the rotational force of the mover and the tilting guide part using the second direction as the center axis based on the second protrusion PR2 cannot be hindered by the elastic member 1144. That is, it is possible to increase driving efficiency.

Furthermore, the second protrusion groove PH2 may not overlap the second groove gr2 in the second direction (the Y-axis direction). The second protrusion groove PH2 may be misaligned with the second groove gr2 in the second direction (the Y-axis direction). As another example, the second protrusion groove PH2 may overlap the second groove gr2 in the second direction (the Y-axis direction). Even in this case, to prevent a reduction in driving efficiency, the second protrusion PR2 may not overlap the second groove gr2 or the elastic member 1144 in the second direction (the Y-axis direction).

As a modified example, the line (or the plane) bisecting the elastic member 1144 in the second direction (the Y-axis direction) and the line (or the plane) bisecting the plurality of first protrusions PR2 in the second direction (the Y-axis direction) may be the same. With this configuration, the holder 1131 may accurately rotate about the second direction (the Y-axis direction) based on the second protrusion PR2.

In addition, at least parts of the first groove gr1 and the second groove gr2 may overlap each other in the optical axis direction or the third direction (the Z-axis direction). Accordingly, the elastic member 1144 may extend in the third direction along the optical axis direction. Alternatively, as will be described below, the elastic member 1144 may extend at a predetermined angle with respect to the optical axis direction.

Furthermore, the first groove gr1 and the second groove gr2 may be located in the region BA1 between the plurality of first protrusions. In addition, the first groove gr1 and the second groove gr2 may be located in the region BA2 between the plurality of second protrusions.

Hereinafter, the arrangement locations of the components will be described based on the center line (e.g., an intersection of the center of gravity or the bisector) of the tilting guide part extending in the third direction. In the optical axis direction, the coupling member 1131a, the elastic member 1144, the sixth housing side portion 1126, the tilting guide part 1141, and the holder 1131 may be sequentially disposed. In addition, the first groove gr1, the second groove gr2, the tilting guide part 1141, and the holder may be disposed sequentially in the optical axis direction.

The first groove gr1 and the second groove gr2 may be disposed to be misaligned with the second protrusion groove PH2 in the second direction (the Y-axis direction). In addition, the first groove gr1 and the second groove gr2 may be disposed to be misaligned with the second protrusion PR2 or the first protrusion PR1 in the second direction. In addition, at least parts of the first groove gr1 and the second groove gr2 may be located to be misaligned with the second protrusion PR2 or the first protrusion PR1 in the optical axis direction or the third direction (the Z-axis direction). In addition, the first groove gr1 and the second groove gr2 may be disposed to be misaligned with the second protrusion PR2 and the first protrusion PR1 in the first direction (the X-axis direction).

In addition, as described above, the elastic member 1144 may be located in the first region. In addition, at least a portion of the elastic member 1144 may be disposed in the second region. The elastic member 1144 may be disposed in the first groove gr1 that passes through a portion of the coupling member 1131a and the second groove gr2 that passes through a portion of the housing side portion (the sixth housing side portion). The elastic member 1144 may overlap the first groove gr1 and the second groove gr2 in the first direction, the second direction, and the third direction.

In addition, the elastic member 1144 may be disposed to be spaced apart from the fourth holder outer surface 1131S4 in the optical axis direction or the third direction (the Z-axis direction). Accordingly, the elastic member 1144 may not overlap the fourth holder outer surface 1131S4 in the second direction. In addition, the elastic member 1144 may be disposed to be misaligned with the fourth holder outer surface 1131S4 in the second direction.

In addition, the elastic member 1144 may also be disposed to be spaced apart from the fourth seating groove in the optical axis direction. The elastic member 1144 may not overlap the fourth seating groove in the first direction and the second direction. In addition, the elastic member 1144 may be disposed to be misaligned with the fourth seating groove in the first direction and the second direction.

The elastic member 1144 may overlap the mover in the optical axis direction. Furthermore, the elastic member 1144 may overlap the coupling member 1131a, the housing side portion (the sixth housing side portion), the plate, and the tilting guide part 1141 in the optical axis direction or the third direction (the Z-axis direction).

The elastic member 1144 may be located between the first extension and the second extension. In addition, the elastic member 1144 may overlap the first extension and the second extension in the second direction. In addition, since the elastic member 1144 is accommodated in the second groove of the sixth housing side portion, the elastic member 1144 may be located between the first through-hole and the second through-hole. At least a portion of the elastic member 1144 may overlap the first through-hole and the second through-hole in the second direction (the Y-axis direction).

In addition, the elastic member 1144 may be located on a plane or line that bisects the first magnet and the second magnet in the second direction or the horizontal direction. In addition, the elastic member 1144 may not overlap the first magnet, the second magnet, and the third magnet in the first direction to the third direction. In an embodiment, the elastic member 1144 may be disposed to be spaced apart from the first magnet and the second magnet in the third direction. For example, the elastic member 1144 may be located at a side opposite to the third direction from the first magnet and the second magnet. Accordingly, it is possible to increase driving efficiency.

In addition, the third magnet may be disposed to be spaced apart from the elastic member 1144 in the optical axis direction. The elastic member 1144 may be located at a side opposite to the third magnet in the third direction. Accordingly, it is possible to increase driving efficiency for axial rotation.

In addition, the tilting guide part 1141 may or may not overlap the first magnet and the second magnet in the second direction. For example, the tilting guide part 1141 may or may not overlap the first magnet and the second magnet in the second direction. Accordingly, the center of gravity of the first camera actuator may be formed adjacent to the elastic member 1144. Accordingly, it is possible to further increase driving efficiency.

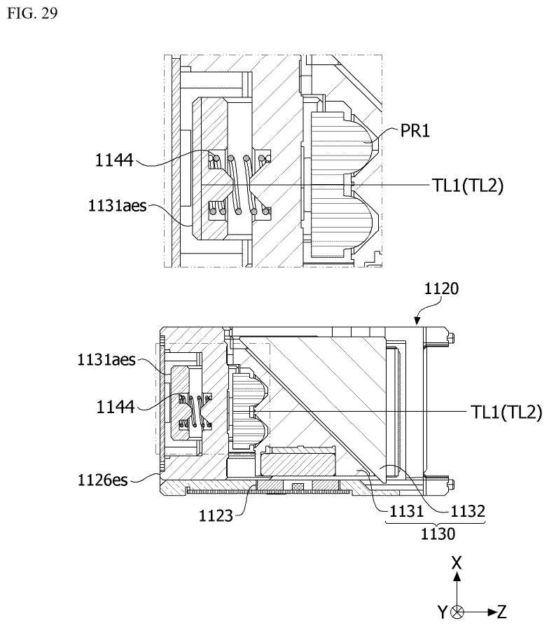

FIG. 29 is a cross-sectional view of a first camera actuator according to yet another embodiment.

Referring to FIG. 29, the first camera actuator according to yet another embodiment may include a housing, a mover, a rotating part, a driving unit, a sixth housing side portion, a coupling member, and a plate. In the present embodiment, it should be understood that the descriptions of the housing, the mover, the rotating part, the driving unit, the sixth housing side portion, the coupling member, and the plate of the first camera actuator according to various embodiments described herein may be applied to the descriptions of the housing, the mover, the rotating part, the driving unit, the sixth housing side portion, the coupling member, and the plate in the same manner unless they are not contradictory.

In the present embodiment, the first groove gr1 may be located below the line bisecting the coupling member 1131a in the first direction. The first groove gr1 may be disposed to be misaligned with the line bisecting the coupling member 1131a in the first direction along the optical axis. Accordingly, the bisector TL2 that bisects the second protrusion and corresponds to the third direction (the Z-axis direction) may be misaligned with the center line TL1 of the elastic member 1144. For example, the bisector TL2 may be located below the center line TL1 of the elastic member 1144. In addition, the bisector TL2 may be a line bisecting the second protrusion PR2 in the first direction (the X-axis direction) and may be provided as a plurality of bisectors. In an embodiment, the bisector TL2 may be spaced apart from the center line TL1 in the first direction (the X-axis direction). With this configuration, the bisector TL2 may be located below the center line TL1. With this configuration, the elastic pressing force may be greatly applied to one region of the tilting guide part 1141. Accordingly, the holder can tilt more precisely with respect to the Y-axis or in a first axis.

Furthermore, the first groove gr1 and the second groove gr2 may overlap the second protrusion PR2 in the third direction. In addition, the above descriptions may be applied in the same manner even when the elastic member 1144 is provided as a plurality of elastic members.

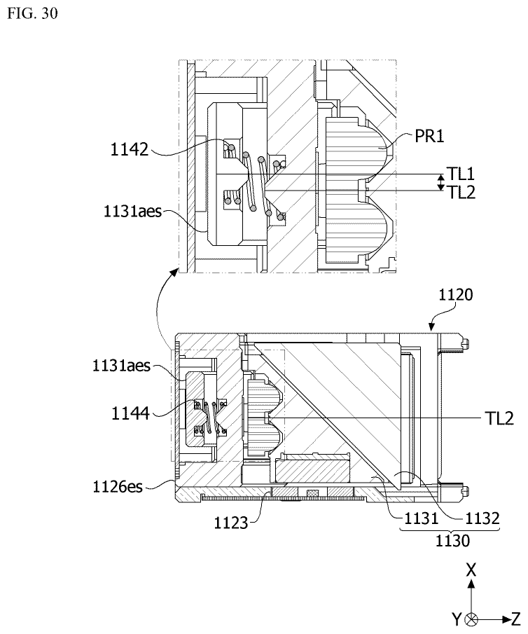

FIG. 30 is a cross-sectional view of a first camera actuator according to yet another embodiment.

Referring to FIG. 30, the first camera actuator according to yet another embodiment may include a housing, a mover, a rotating part, a driving unit, a sixth housing side portion, a coupling member, and a plate. In the present embodiment, it should be understood that the descriptions of the housing, the mover, the rotating part, the driving unit, the sixth housing side portion, the coupling member, and the plate of the first camera actuator according to various embodiments described herein may be applied to the descriptions of the housing, the mover, the rotating part, the driving unit, the sixth housing side portion, the coupling member, and the plate in the same manner unless they are not contradictory.

A portion of the first groove gr1 may overlap the second groove gr2 in the third direction (the Z-axis direction). In addition, a portion of the first groove gr1 may be misaligned with the second groove gr2 in the third direction (the Z-axis direction). That is, a portion of the first groove gr1 may not overlap the second groove gr2 in the third direction (the Z-axis direction). With this configuration, the direction or size of the elastic restoring force can suitably vary according to the location between the mover 1130 and the tilting guide part 1141.

In addition, the above descriptions may be applied in the same manner even when the elastic member 1144 is provided as a plurality of elastic members. However, angles at which the plurality of elastic members are tilted in the first direction with respect to the third direction (the Z-axis direction) may be different or the same.

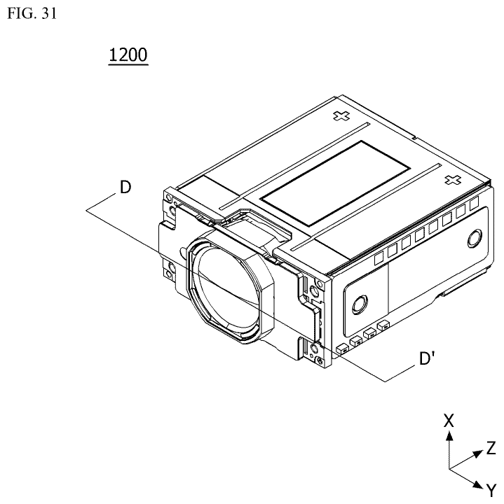

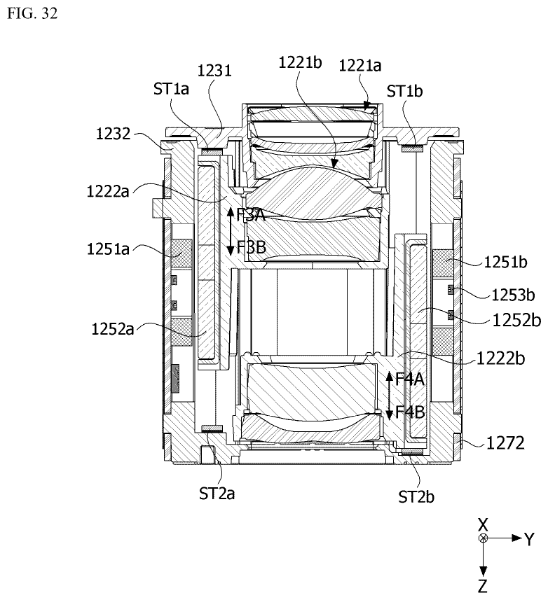

FIG. 31 is a perspective view of a second camera actuator according to the embodiment, and FIG. 32 is a view along line DD′ in FIG. 31.

Referring to FIGS. 31 and 32, the second camera actuator 1200 according to the embodiment may include the single lens or the plurality of lenses LGT and LG2 as described above.

The second camera actuator may include a driving unit and move at least one of the plurality of lenses along the optical axis or the third direction (the Z-axis direction) by the driving unit. According to the driving forces F3A, F3B, F4A, and F4B generated by the driving unit, the lenses LGT and LG2 may move individually or integrally. In an embodiment, each lens may move in the optical axis direction.

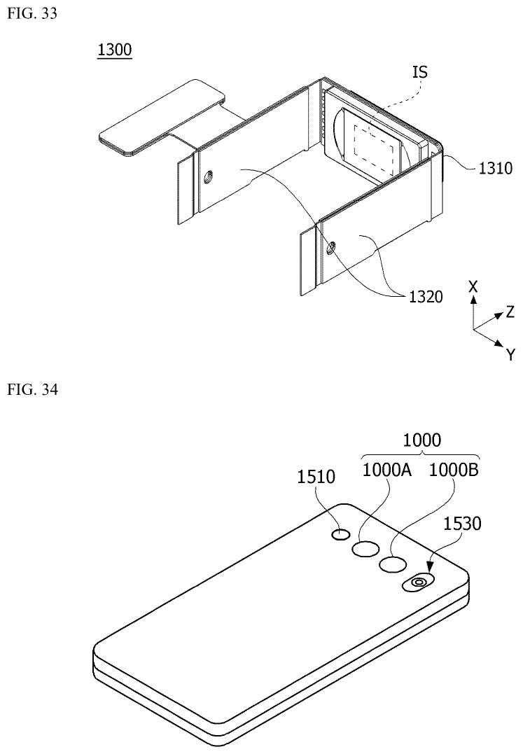

FIG. 33 is a schematic view illustrating a circuit board according to the embodiment.

Referring to FIG. 33, as described above, the circuit board 1300 according to the embodiment may include a first circuit board 1310 and a second circuit board 1320. The first circuit board 1310 may be located under the base and coupled to the base. In addition, the image sensor IS may be disposed on the first circuit board 1310. In addition, the first circuit board 1310 and the image sensor IS may be electrically connected. That is, the base may be located behind the second camera actuator, and the image sensor and the circuit board (first circuit board part) may be located behind the base. The base may include a filter (e.g., infrared rays).

In addition, the second circuit board 1320 may be located at a side portion of the base. In particular, the second circuit board 1320 may be located at a first side portion of the base. Accordingly, the second circuit board 1320 may be located adjacent to the fourth coil located adjacent to the first side portion, thus an electrical connection can be easy. In addition, the second circuit board 1320 may be located at the second side portion. As described above, the second circuit board 1320 may be provided as a plurality of second circuit boards. However, the embodiments of the present invention are not limited thereto, and the second circuit board 1320 may be disposed on only one of the first side portion and the second side portion.

Furthermore, the circuit board 1300 may further include a fixed board (not illustrated) located at a side surface thereof. Accordingly, even when the circuit board 1300 is formed of a flexible material, the circuit board 1300 may be coupled to the base while maintaining stiffness by the fixed board.

The second circuit board 1320 of the circuit board 1300 may be located at the side portion of the driving unit of the second camera actuator. The circuit board 1300 may be electrically connected to the first driving unit of the first camera actuator and the second driving unit of the second camera actuator. For example, electrical connection may be made by a surface mounting technology (SMT). However, the embodiments of the present invention are not limited to such a method.

The circuit board 1300 may include a circuit board having line patterns that may be electrically connected, such as a rigid printed circuit board (PCB), a flexible PCB, a rigid-flexible PCB, etc. However, the embodiments of the present invention are not limited to these types.

In addition, the circuit board 1300 may be electrically connected to another camera module in the terminal or a processor of the terminal. Accordingly, the above camera actuator and camera module including the same may transmit and receive any signal in the terminal.

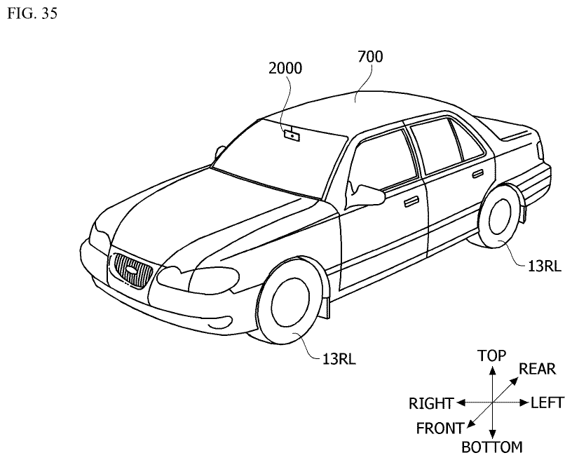

FIG. 34 is a perspective view of a mobile terminal to which the camera module according to the embodiment is applied.

As illustrated in FIG. 34, a mobile terminal 1500 of the embodiment may include a camera module 1000, a flash module 1530, and an AF device 1510, which are provided on a rear surface thereof.

The camera module 1000 may include an image capturing function and an AF function. For example, the camera module 1000 may include the AF function using an image.

The camera module 1000 processes an image frame of a still image or a moving image obtained by an image sensor in a capturing mode or a video call mode.

The processed image frame may be displayed on a predetermined display and stored in a memory. A camera (not illustrated) may also be disposed on a front surface of a body of the mobile terminal.

For example, the camera module 1000 may include a first camera module 1000A and a second camera module 1000B, and the first camera module 1000A may implement an OIS function along with an AF or zooming function.

The flash module 1530 may include a light-emitting element for emitting light therein. The flash module 1530 may be operated by a camera operation of the mobile terminal or a user's control.

The AF device 1510 may include one of a package of a surface light-emitting laser element as a light-emitting part.

The AF device 1510 may include the AF function using a laser. The AF device 1510 may be mainly used in a condition that the AF function using the image of the camera module 1000 is degraded, for example, a proximity of 10 m or less or dark environment.

The AF device 1510 may include a light-emitting part including a vertical cavity surface emitting laser (VCSEL) semiconductor device and a light-receiving part for converting light energy into electrical energy, such as a photodiode.

FIG. 35 is a perspective view of a vehicle to which the camera module according to the embodiment is applied.

For example, FIG. 35 is an external view of the vehicle including a vehicle driving assistance device to which the camera module 1000 according to the embodiment is applied.

Referring to FIG. 35, a vehicle 700 according to the embodiment may include wheels 13FL and 13FR rotated by a power source and a predetermined sensor. The sensor may be a camera sensor 2000, but is not limited thereto.

The camera sensor 2000 may be a camera sensor to which the camera module 1000 according to the embodiment is applied. The vehicle 700 according to the embodiment may acquire image information through the camera sensor 2000 for capturing a forward image or a surrounding image, determine a situation in which a lane is not identified using the image information, and generate a virtual lane when the lane is not identified.

For example, the camera sensor 2000 may acquire a forward image by capturing a forward view of the vehicle 700, and a processor (not illustrated) may acquire image information by analyzing an object included in the forward image.

For example, when a lane, a nearby vehicle, a traveling obstacle, and objects, such as a median, a curb, or a tree corresponding to an indirect road mark, are captured in the image captured by the camera sensor 2000, the processor may detect the object and include the detected object in the image information. In this case, the processor may further supplement the image information by acquiring distance information to the object detected through the camera sensor 2000.

The image information may be information about the object captured in the image. The camera sensor 2000 may include an image sensor and an image processing module.

The camera sensor 2000 may process still images or moving images obtained by the image sensor (e.g., a complementary metal-oxide semiconductor (CMOS) or a charge-coupled device (CCD)).

The image processing module may process the still images or moving images acquired through the image sensor to extract necessary information and transmit the extracted information to the processor.

In this case, the camera sensor 2000 may include a stereo camera capable of improving the measurement accuracy of the object and further securing information such as a distance between the vehicle 700 and the object, but is not limited thereto.

Although embodiments have been mainly described above, these embodiments are only illustrative and do not limit the present invention, and those skilled in the art to which the present invention pertains can know that various modifications and applications that are not exemplified above are possible without departing from the essential characteristics of the embodiments. For example, each component specifically shown in the embodiments may be implemented by modification thereof. In addition, differences related to these modifications and applications should be construed as being included in the scope of the present invention defined in the appended claims.

1-10. (canceled)

11. A camera actuator comprising:
a housing including a first housing side portion and a second housing side portion spaced apart from each other;
a mover disposed between the first housing side portion and the second housing side portion and including a holder and an optical member disposed on the holder;
a driving unit that moves the mover in an optical axis direction; and
a tilting guide part that is disposed between the housing and the mover and guides tilting of the mover,
wherein the housing includes a housing wall portion that extends from the first housing side portion and the second housing side portion and overlaps at least a portion of the holder in the optical axis direction, and
wherein the housing wall portion is spaced apart from the holder in the optical axis direction.

12. The camera actuator of claim 11, further comprising:
a first magnetic body disposed in the housing; and
a second magnetic body disposed to face the first magnetic body,
wherein the tilting guide part presses the mover due to a repulsive force between the first magnetic body and the second magnetic body.

13. The camera actuator of claim 12, wherein a gap between the first magnetic body and the second magnetic body is greater than a gap between the holder and the housing wall portion facing each other in the optical axis direction.

14. The camera actuator of claim 12, wherein the housing includes a first member disposed at one side thereof,
wherein the mover includes a second member passing through the first member,
wherein the tilting guide part is disposed between the first member and the mover, and
wherein a gap between the first member and the second member is greater than a gap between the holder and the housing wall portion in the optical axis direction.

15. The camera actuator of claim 14, wherein the first member includes a second groove located at an outer surface thereof,
wherein the second member includes a first groove facing the second groove,
wherein the first magnetic body is disposed in the second groove, and
wherein the second magnetic body is disposed in the first groove.

16. The camera actuator of claim 15, wherein the first groove and the second groove overlap each other in the optical axis direction.

17. The camera actuator of claim 11, wherein the housing wall portion does not overlap the optical member in the optical axis direction.

18. The camera actuator of claim 11, wherein at least a portion of the housing wall portion overlaps the holder in a direction perpendicular to the optical axis direction.

19. The camera actuator of claim 11, wherein the driving unit includes a first magnet, a second magnet facing the first magnet, and a third magnet disposed between the second magnet and the second magnet.

20. The camera actuator of claim 19, wherein the housing wall portion overlaps at least one of the first magnet and the second magnet in the optical axis direction.

21. The camera actuator of claim 19, wherein the optical member is disposed between the first magnet and the second magnet.

22. The camera actuator of claim 11, wherein the housing wall portion includes a housing extension extending to an upper portion of the holder.

23. The camera actuator of claim 22, wherein the housing includes a first member disposed at one side thereof, the mover includes a second member passing through the first member, the tilting guide part is disposed between the first member and the mover, and a gap between the first member and the second member is greater than a gap between the holder and the housing extension.

24. The camera actuator of claim 23, wherein the housing wall portion does not overlap the first magnetic body, the second magnetic body, and the second member in the optical axis direction.

25. The camera actuator of claim 23, wherein a gap between the first member and the second member facing each other in a direction perpendicular to the optical axis direction is greater than a gap between an upper surface of the holder and a lower surface of the housing extension.

26. The camera actuator of claim 11, wherein the tilting guide part includes a plurality of first protrusions spaced apart from each other in a first direction and a plurality of second protrusions spaced apart from each other in a second direction perpendicular to the first direction.

27. The camera actuator of claim 26, wherein the mover includes a plurality of first protrusion grooves in which the plurality of second protrusions are disposed, and the housing includes a plurality of second protrusion grooves in which the plurality of first protrusions are disposed.

28. The camera actuator of claim 27, wherein at least one of the plurality of first protrusion grooves includes an odd number of inclined surfaces, and a first boundary surface between adjacent inclined surfaces among the odd number of inclined surfaces is bisected by a plane perpendicular to the first direction.

29. The camera actuator of claim 28, wherein one of the odd number of inclined surfaces is bisected by the plane perpendicular to the first direction.

30. The camera actuator of claim 27, wherein at least one of the plurality of second protrusion grooves includes an odd number of inclined surfaces, and a second boundary surface between adjacent inclined surfaces among the odd number of inclined surfaces is bisected by a plane perpendicular to the second direction.
